(19) United States
(12) Patent Application Publication
(10) Pub. No.: US 2022/0342516 A1
(43) Pub. Date: Oct. 27, 2022

(54) Display Method for Electronic Device, Electronic Device, and Computer-Readable Storage Medium

(71) Applicant: Huawei Technologies Co., Ltd., Shenzhen, Guangdong (JP)

(72) Inventors: Hao Chen, Shenzhen (CN); Aihua Zheng, Shenzhen (CN); Xiaoxiao Chen, Nanjing (CN); Qing Wang, Wuhan (CN); Jianfeng Wang, Shenzhen (CN)

(21) Appl. No.: 17/765,124

(22) PCT Filed: Sep. 23, 2020
(86) PCT No.: PCT/CN2020/116985

§ 371 Date: Mar. 30, 2022

(30) Foreign Application Priority Data
Sep. 30, 2019 (CN) 201910943951.5

(51) Int. Cl. G06F 3/0481; G06F 3/0486; H04M 1/04

(52) U.S. Cl. CPC G06F 3/0481; G06F 3/0486; H04M 1/04; G06F 2203/04803

(57) ABSTRACT

In a display method for an electronic device, on one hand, when a screen ratio of a first screen of the electronic device does not meet a preset ratio requirement, a display interface of a first application is displayed in a first area on the first screen; and a shortcut function control is displayed in a second area on the first screen, where a screen ratio of the first area meets the ratio requirement; on the other hand, the display interface of the first application is displayed on the first screen when the screen ratio of the first screen meets the ratio requirement.

This application claims priority to Chinese Patent Application No. 201910943951.5, filed with the China National Intellectual Property Administration on Sep. 30, 2019 and entitled “DISPLAY METHOD FOR ELECTRONIC DEVICE, ELECTRONIC DEVICE, AND COMPUTER-READABLE STORAGE MEDIUM”, which is incorporated herein by reference in its entirety.

### TECHNICAL FIELD

This solution relates to the computer field, and in particular, to a display method for an electronic device, an electronic device, and a computer-readable storage medium.

### BACKGROUND

A foldable phone and a curved phone have entered people's lives as flexible display technologies develop. A foldable phone is used as an example. The mobile phone displays content with different screen sizes in an unfolded state and a folded state. For example, FIG. 1a and FIG. 1b are a schematic diagram of display interfaces according to the conventional technology. A mobile phone displays content on a screen 110 with a size of 20 mm×250 mm in an unfolded state, and may display content on a screen 120 with a size of 90 mm×250 mm in a folded state.

A form of an ultra-long screen easily occurs when an electronic device has a foldable screen. For example, a length-width ratio of the screen 120 is 25:9. However, a current application (Application, app) is usually designed within a length-width ratio range of 4:3 to 21:9, and the size of the screen 120 and the size of the application do not match. This results in screen resource waste.

### SUMMARY

Embodiments of this application provide a display method for an electronic device, an electronic device, and a computer-readable storage medium, to improve screen resource utilization.

According to a first aspect, an embodiment of this application provides a display method for an electronic device. When the electronic device displays content on a first screen, on one hand, when a screen ratio of the first screen (for example, a screen 120 in a folded state, or a screen 110 of a mobile phone in an unfolded state) does not meet a preset ratio requirement, a display interface of a first application is displayed in a first area on the first screen; and a shortcut function control is displayed in a second area on the first screen, where a screen ratio of the first area meets the ratio requirement; on the other hand, the display interface of the first application is displayed on the first screen when the screen ratio of the first screen meets the ratio requirement. For example, as shown in FIG. 4a and FIG. 4b, when a mobile phone is in a folded state, if a screen 120 works, a screen 121 displays a launcher, and a screen 122 displays a screen switching control; and when a screen 130 works, the screen 130 displays the launcher. Therefore, according to the technical solution provided in this embodiment of this application, an appropriate screen size can be used to display the content, and the shortcut function control can be displayed in the second area, so that a user can use an application terminal more conveniently, thereby improving screen resource utilization.

In this embodiment of this application, the shortcut function control includes at least one of the following:

A screen switching control is configured to switch from the first screen to a second screen. For example, the screen switching control is the screen switching control shown in FIG. 4a and FIG. 4b. In response to a touch control operation performed by a user in an area on the screen 122, the screen 130 is turned on, content is displayed on the screen 130, and the screen 120 is turned off.

An associated control of the first application is configured to implement a shortcut function associated with the first application. For example, in the embodiment shown in FIG. 3a to FIG. 3c, one or more images recently captured by a camera application may be displayed on the screen 122.

An icon control of a second application is configured to start the second application. For example, in an interface in FIG. 7a, icon controls of one or more applications may be displayed on a screen 122, so that the application can be started in response to a touch control operation performed by a user on the icon control.

A function control of a third application is configured to enable a shortcut function of the third application. For example, in an interface in FIG. 7b, a cart function control in a shopping application, a video playing function control in a video application, and a scan function control may be displayed on a screen 122, and a mobile phone 100 may also start, in response to touch control operations performed by the user on these function controls, applications to which these function controls belong, for example, the video application and the shopping application, or start a function, for example, start a camera.

A switch control is configured to enable or disable a shortcut function of the electronic device. For example, in an embodiment shown in FIG. 6a and FIG. 6b, a switch control used for controlling a Bluetooth switch, a switch control used for controlling a Wi-Fi switch, and a switch control used for controlling a mobile phone to be in an airplane mode may be displayed on a screen 122.

In a specific embodiment, as shown in FIG. 4a and FIG. 4b, when the first application is the camera application, the associated control is the one or more images recently captured by the camera application.

In this embodiment of this application, when the icon control of an application (the second application) is displayed in the second area on the first screen, icon controls of the following one or more applications may be displayed: the top one or more applications ranked in descending order of quantities of times of being opened by a user in a first time interval; the top one or more applications ranked in descending order of duration (maximum duration of a single use, or accumulated duration in a period of time) of being used by the user in a second time interval; and one or more applications specified by the user, where the first time interval may be the same as or different from the second time interval, and this is not limited herein. In addition, icon controls of some applications may be displayed in a fixed manner.

In this embodiment of this application, when the function control of the third application is displayed in the second area on the first screen, function controls of the following one or more applications may be displayed: the top one or more function controls ranked in descending order of quantities of times of being opened by a user in a third time interval; the top one or more function controls ranked in descending order of duration of being used by the user in a fourth time interval, where the third time interval may be the same as or different from the fourth time interval, and this is not limited herein; and one or more function controls specified by the user.

In an embodiment, the plurality of shortcut function controls are displayed in order in the second area on the first screen, for example, a screen 122 or a screen 113, where the order is associated with user data. For example, the controls are displayed in descending order of quantities of times that the user enables these shortcut functions, or the controls are displayed in descending order of duration in which the user uses these shortcut function controls.

In another embodiment, the plurality of shortcut function controls are displayed in categories in the second area on the first screen. In a possible scenario, the screen 122 may present the shortcut function controls on a plurality of pages. For example, a screen switching control is displayed on a first page, an associated control of the first application is displayed on a second page, an icon control of the second application is displayed on a third page, a function control of the third application is displayed on a fourth page, and a switch control is displayed on a fifth page.

In this embodiment of this application, a display interface of the second application is displayed in the first area in response to a touch control operation performed by the user on the icon control. For example, in a scenario shown in FIG. 8a and FIG. 8b, a display interface of a phone application is displayed on a screen 121 if a user taps a control 1225 on a screen 122.

In this embodiment of this application, a display interface of the shortcut function of the third application is displayed in the first area in response to a touch control operation performed by the user on the function control. For example, if the user taps the function control used for implementing code scanning on the screen 122, a code scanning preview interface is displayed on the screen 121. The interface may be the same as or different from the interface of the camera application.

In this embodiment of this application, in response to the touch control operation performed by the user on the screen switching control, the first screen is turned off, the second screen is turned on, and the display interface of the first application is displayed on the second screen. As shown in FIG. 4a and FIG. 4b, details are not described again.

In this embodiment of this application, the first screen is a primary screen or a secondary screen of the electronic device in a folded state. For example, the screen 120 may be the first screen. In this case, the screen 120 may be used as a secondary screen of the electronic device in the folded state.

In addition, when the electronic device is in an unfolded state and is in a multi-application mode, the first screen further includes a third area; and a display interface of a fourth application is displayed in the third area, where a screen ratio of the third area meets the ratio requirement. For example, in a scenario shown in FIG. 11a and FIG. 11b, a first screen is a screen 110, a first area is an area in which a screen 112 is located, a second area is an area in which a screen 113 is located, and a third area is an area in which a screen 111 is located. For example, as shown in FIG. 12a to FIG. 14b, a third area may display a display interface of another application different from the application in the first area. In addition, a length-width ratio of the screen 111 meets the preset ratio requirement.

In this scenario, the display interface of the first application is displayed in the third area in response to a received touch control operation of dragging the first application from the first area to the third area, for example, the scenario shown in FIG. 14a and FIG. 14b.

In this embodiment of this application, the electronic device further includes a side display area, and the side display area is formed by a flexible display.

In a possible design, as shown in FIG. 15a and FIG. 15b or FIG. 16a and FIG. 16b, the side display area is a part of the first screen.

In this case, refer to FIG. 15a and FIG. 15b. The side display area includes two game button areas disposed at the top and the bottom respectively, and when the electronic device starts a game application, the game button area is used to implement a game skill in response to a touch control operation performed by the user.

The side display area includes a volume area, and the volume area is used to increase or decrease volume of the electronic device in response to a touch control performed by the user.

In this embodiment of this application, the preset ratio requirement is that a screen ratio falls between 4:3 and 21:9. Therefore, if the length-width ratio of the screen is greater than 21:9, or the length-width ratio of the screen is less than 4:3, the screen can be split into two areas to display different content, thereby implementing proper use of screen resources.

According to a second aspect, an embodiment of this application provides an electronic device including: one or more processors; one or more memories; and one or more computer programs, where the one or more computer programs are stored in the one or more memories, the one or more computer programs include instructions, and when the instructions are executed by the electronic device, the electronic device is enabled to perform the following method:

When the electronic device displays content on a first screen, on one hand, when a screen ratio of the first screen (for example, a screen 120 in a folded state, or a screen 110 of a mobile phone in an unfolded state) does not meet a preset ratio requirement, a display interface of a first application is displayed in a first area on the first screen; and a shortcut function control is displayed in a second area on the first screen, where a screen ratio of the first area meets the ratio requirement; on the other hand, the display interface of the first application is displayed on the first screen when the screen ratio of the first screen meets the ratio requirement. For example, as shown in FIG. 4a and FIG. 4b, when a mobile phone is in a folded state, if a screen 120 works, a screen 121 displays a launcher, and a screen 122 displays a screen switching control; and when a screen 130 works, the screen 130 displays the launcher. Therefore, according to the technical solution provided in this embodiment of this application, an appropriate screen size can be used to display the content, and the shortcut function control can be displayed in the second area, so that a user can use an application terminal more conveniently, thereby improving screen resource utilization.

In this embodiment of this application, the shortcut function control includes at least one of the following:

A screen switching control is configured to switch from the first screen to a second screen. For example, the screen switching control is the screen switching control shown in FIG. 4a and FIG. 4b. In response to a touch control operation performed by a user in an area on the screen 122, the screen 130 is turned on, content is displayed on the screen 130, and the screen 120 is turned off.

An associated control of the first application is configured to implement a shortcut function associated with the first application. For example, in the embodiment shown in FIG. 3a to FIG. 3c, one or more images recently captured by a camera application may be displayed on the screen 122.

An icon control of a second application is configured to start the second application. For example, in an interface in FIG. 7a, icon controls of one or more applications may be displayed on a screen 122, so that the application can be started in response to a touch control operation performed by a user on the icon control.

A function control of a third application is configured to enable a shortcut function of the third application. For example, in an interface in FIG. 7b, a cart function control in a shopping application, a video playing function control in a video application, and a scan function control may be displayed on a screen 122, and a mobile phone 100 may also start, in response to touch control operations performed by the user on these function controls, applications to which these function controls belong, for example, the video application and the shopping application, or start a function, for example, start a camera.

A switch control is configured to enable or disable a shortcut function of the electronic device. For example, in an embodiment shown in FIG. 6a and FIG. 6b, a switch control used for controlling a Bluetooth switch, a switch control used for controlling a Wi-Fi switch, and a switch control used for controlling a mobile phone to be in an airplane mode may be displayed on a screen 122.

In a specific embodiment, as shown in FIG. 4a and FIG. 4b, when the first application is the camera application, the associated control is the one or more images recently captured by the camera application.

In this embodiment of this application, when the icon control of an application (the second application) is displayed in the second area on the first screen, icon controls of the following one or more applications may be displayed: the top one or more applications ranked in descending order of quantities of times of being opened by a user in a first time interval; the top one or more applications ranked in descending order of duration (maximum duration of a single use, or accumulated duration in a period of time) of being used by the user in a second time interval; and one or more applications specified by the user, where the first time interval may be the same as or different from the second time interval, and this is not limited herein. In addition, icon controls of some applications may be displayed in a fixed manner.

In this embodiment of this application, when the function control of the third application is displayed in the second area on the first screen, function controls of the following one or more applications may be displayed: the top one or more function controls ranked in descending order of quantities of times of being opened by a user in a third time interval; the top one or more function controls ranked in descending order of duration of being used by the user in a fourth time interval, where the third time interval may be the same as or different from the fourth time interval, and this is not limited herein; and one or more function controls specified by the user.

In an embodiment, the plurality of shortcut function controls are displayed in order in the second area on the first screen, for example, a screen 122 or a screen 113, where the order is associated with user data. For example, the controls are displayed in descending order of quantities of times that the user enables these shortcut functions, or the controls are displayed in descending order of duration in which the user uses these shortcut function controls.

In another embodiment, the plurality of shortcut function controls are displayed in categories in the second area on the first screen. In a possible scenario, the screen 122 may present the shortcut function controls on a plurality of pages. For example, a screen switching control is displayed on a first page, an associated control of the first application is displayed on a second page, an icon control of the second application is displayed on a third page, a function control of the third application is displayed on a fourth page, and a switch control is displayed on a fifth page.

In this embodiment of this application, a display interface of the second application is displayed in the first area in response to a touch control operation performed by the user on the icon control. For example, in a scenario shown in FIG. 8a and FIG. 8b, a display interface of a phone application is displayed on a screen 121 if a user taps a control 1225 on a screen 122.

In this embodiment of this application, a display interface of the shortcut function of the third application is displayed in the first area in response to a touch control operation performed by the user on the function control. For example, if the user taps the function control used for implementing code scanning on the screen 122, a code scanning preview interface is displayed on the screen 121. The interface may be the same as or different from the interface of the camera application.

In this embodiment of this application, in response to the touch control operation performed by the user on the screen switching control, the first screen is turned off, the second screen is turned on, and the display interface of the first application is displayed on the second screen. As shown in FIG. 4a and FIG. 4b, details are not described again.

In this embodiment of this application, the first screen is a primary screen or a secondary screen of the electronic device in a folded state. For example, the screen 120 may be the first screen. In this case, the screen 120 may be used as a secondary screen of the electronic device in the folded state.

In addition, when the electronic device is in an unfolded state and is in a multi-application mode, the first screen further includes a third area; and a display interface of a fourth application is displayed in the third area, where a screen ratio of the third area meets the ratio requirement. For example, in a scenario shown in FIG. 11a and FIG. 11b, a first screen is a screen 110, a first area is an area in which a screen 112 is located, a second area is an area in which a screen 113 is located, and a third area is an area in which a screen 111 is located. For example, as shown in FIG. 12a to FIG. 14b, a third area may display a display interface of another application different from the application in the first area. In addition, a length-width ratio of the screen 111 meets the preset ratio requirement.

In this scenario, the display interface of the first application is displayed in the third area in response to a received touch control operation of dragging the first application from the first area to the third area, for example, the scenario shown in FIG. 14a and FIG. 14b.

In this embodiment of this application, the electronic device further includes a side display area, and the side display area is formed by a flexible display.

In a possible design, as shown in FIG. 15a and FIG. 15b or FIG. 16a and FIG. 16b, the side display area is a part of the first screen.

In this case, refer to FIG. 15a and FIG. 15b. The side display area includes two game button areas disposed at the top and the bottom respectively, and when the electronic device starts a game application, the game button area is used to implement a game skill in response to a touch control operation performed by the user.

The side display area includes a volume area, and the volume area is used to increase or decrease volume of the electronic device in response to a touch control performed by the user.

In this embodiment of this application, the preset ratio requirement is that a screen ratio falls between 4:3 and 21:9. Therefore, if the length-width ratio of the screen is greater than 21:9, or the length-width ratio of the screen is less than 4:3, the screen can be split into two areas to display different content, thereby implementing proper use of screen resources.

According to a third aspect, an embodiment of this application provides a computer storage medium, including computer instructions. When the computer instructions are run on an electronic device, the electronic device is enabled to perform the method according to any possible design of any one of the foregoing aspects.

According to a fourth aspect, an embodiment of this application provides a computer program product. When the computer program product runs on a computer, the computer is enabled to perform the method according to any possible design of any one of the foregoing aspects.

In conclusion, the display method for the electronic device, the electronic device, and the computer-readable storage medium that are provided in embodiments of this application can improve screen resource utilization.

### BRIEF DESCRIPTION OF DRAWINGS

FIG. 1a and FIG. 1B are a schematic diagram of display interfaces according to the conventional technology;

FIG. 2 is a schematic diagram of a structure of an electronic device according to an embodiment of this application;

FIG. 3a to FIG. 3c are a schematic diagram of a physical structure of an electronic device according to an embodiment of this application;

FIG. 4a and FIG. 4b are a schematic diagram of display interfaces of an electronic device according to an embodiment of this application;

FIG. 5a and FIG. 5b are a schematic diagram of other display interfaces of an electronic device according to an embodiment of this application;

FIG. 6a and FIG. 6b are a schematic diagram of other display interfaces of an electronic device according to an embodiment of this application;

FIG. 7a and FIG. 7b are a schematic diagram of other display interfaces of an electronic device according to an embodiment of this application;

FIG. 8a and FIG. 8b are a schematic diagram of other display interfaces of an electronic device according to an embodiment of this application;

FIG. 9 is a schematic diagram of another display interface of an electronic device according to an embodiment of this application;

FIG. 10a and FIG. 10b are a schematic diagram of other display interfaces of an electronic device according to an embodiment of this application;

FIG. 11a and FIG. 11b are a schematic diagram of other display interfaces of an electronic device according to an embodiment of this application;

FIG. 12a and FIG. 12b are a schematic diagram of other display interfaces of an electronic device according to an embodiment of this application;

FIG. 13a and FIG. 13b are a schematic diagram of other display interfaces of an electronic device according to an embodiment of this application;

FIG. 14a and FIG. 14b are a schematic diagram of other display interfaces of an electronic device according to an embodiment of this application;

FIG. 15a and FIG. 15b are a schematic diagram of other display interfaces of an electronic device according to an embodiment of this application;

FIG. 16a and FIG. 16b are a schematic diagram of other display interfaces of an electronic device according to an embodiment of this application;

FIG. 17a and FIG. 17b are a schematic diagram of other display interfaces of an electronic device according to an embodiment of this application;

FIG. 18 is a schematic diagram of a system architecture of an electronic device according to an embodiment of this application; and

FIG. 19 is a schematic flowchart of a display method for an electronic device according to an embodiment of this application.

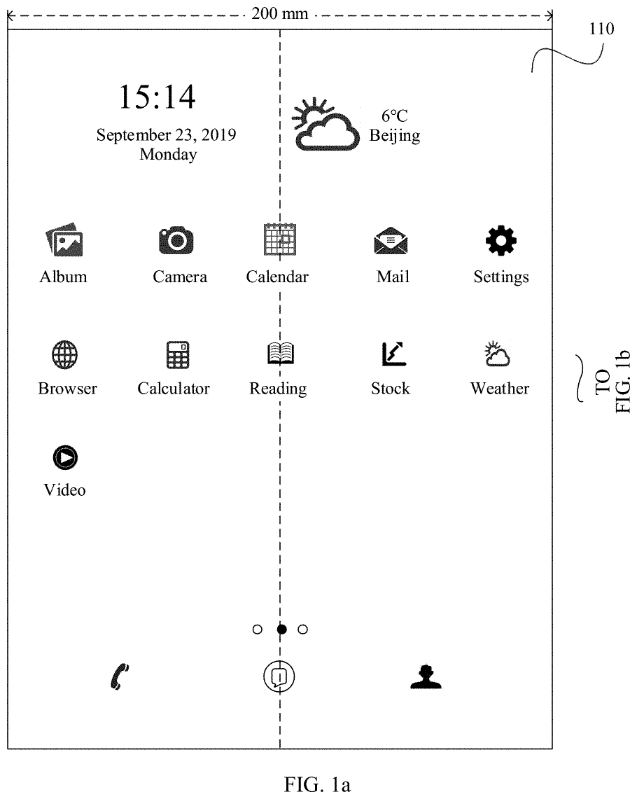

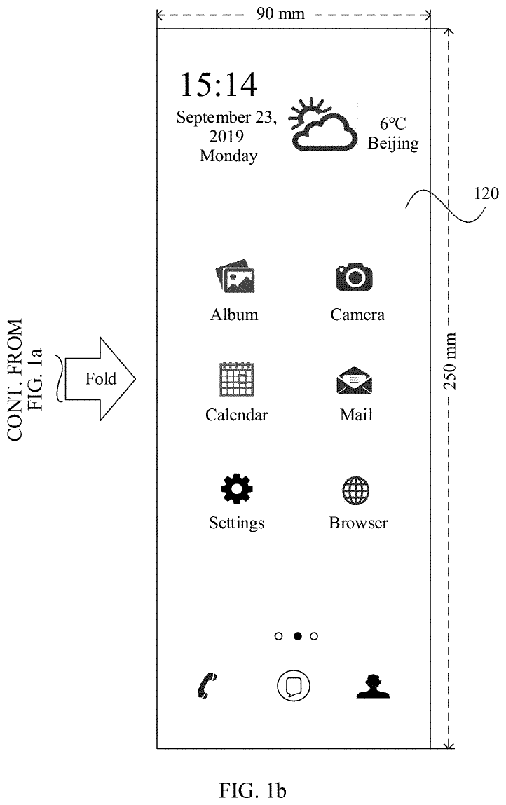

### DESCRIPTION OF EMBODIMENTS

The following describes implementations of embodiments in detail with reference to the accompanying drawings. In the descriptions of embodiments of this application, “I” means “or” unless otherwise specified. For example, AB may represent A or B. In this specification, “and/or” describes only an association relationship for describing associated objects and represents that three relationships may exist. For example, A and/or B may represent the following three cases: Only A exists, both A and B exist, and only B exists. In addition, in the descriptions of embodiments of this application, “a plurality of” means two or more than two.

Embodiments of this application provide a display method for an electronic device having a flexible display, which may be applied to an electronic device having a flexible display, such as a mobile phone, a tablet computer, a notebook computer, an ultra-mobile personal computer (ultra-mobile personal computer, UMPC), a hand-held computer, a netbook, a personal digital assistant (personal digital assistant, PDA), a wearable device, or a virtual reality device. This is not limited in embodiments of this application.

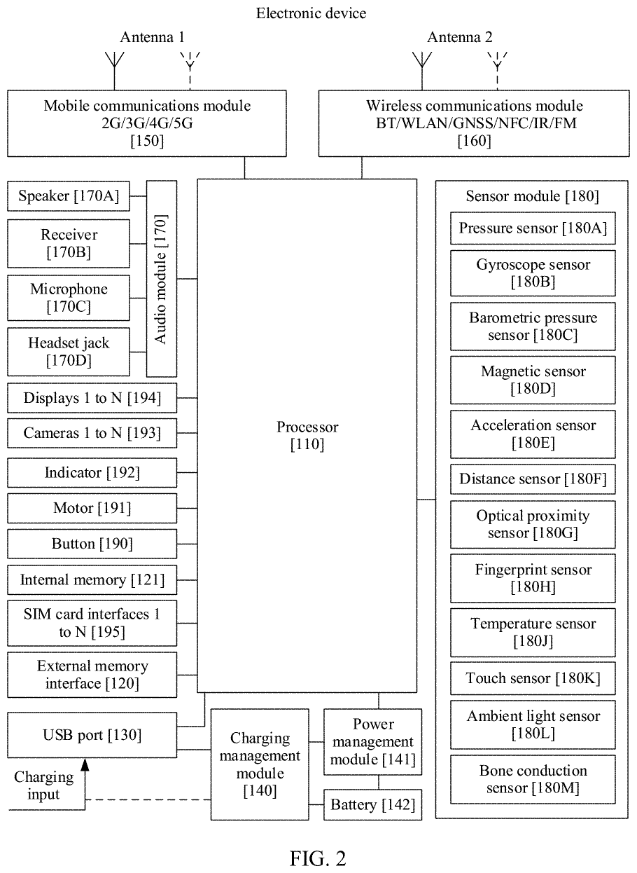

For example, a mobile phone 100 is the electronic device. FIG. 2 is a schematic diagram of a structure of the mobile phone.

The electronic device may include a processor 110, an external memory interface 120, an internal memory 121, a universal serial bus (universal serial bus, USB) port 130, a charging management module 140, a power management module 141, a battery 142, an antenna 1, an antenna 2, a mobile communications module 150, a wireless communications module 160, an audio module 170, a speaker 170A, a receiver 170B, a microphone 170C, a headset jack 170D, a sensor 180, a button 190, a motor 191, an indicator 192, a camera 193, a display 194, a subscriber identity module (subscriber identity module, SIM) card interface 195, and the like.

It may be understood that a structure illustrated in this embodiment of this application does not constitute a specific limitation on the mobile phone 100. In some other embodiments of this application, the mobile phone 100 may include more or fewer components than those shown in the figure, or some components are combined, or some components are split, or component arrangements are different. The components shown in the figure may be implemented in hardware, software, or a combination of software and hardware.

The processor 110 may include one or more processing units. For example, the processor 110 may include an application processor (application processor, AP), a modem processor, a graphics processing unit (graphics processing unit, GPU), an image signal processor (image signal processor, ISP), a controller, a video codec, a digital signal processor (digital signal processor, DSP), a baseband processor, and/or a neural-network processing unit (neural-network processing unit, NPU). Different processing units may be independent devices, or may be integrated into one or more processors. In some embodiments, the electronic device may also include one or more processors 110. The controller may be a nerve center and a command center of the electronic device. The controller may generate an operation control signal based on instruction operation code and a time sequence signal, to complete control of instruction fetching and instruction execution. A memory may be disposed in the processor 110, and is configured to store instructions and data. In some embodiments, the memory in the processor 110 is a cache memory. The memory may store instructions or data just used or cyclically used by the processor 110. If the processor 110 needs to use the instructions or the data again, the processor 110 may directly invoke the instructions or the data from the memory. This avoids repeated access and reduces waiting time of the processor 110, thereby improving efficiency of the electronic device.

In some embodiments, the processor 110 may include one or more interfaces. The interface may include an inter-integrated circuit (inter-integrated circuit, I2C) interface, an inter-integrated circuit sound (inter-integrated circuit sound, I2S) interface, a pulse code modulation (pulse code modulation, PCM) interface, a universal asynchronous receiver/transmitter (universal asynchronous receiver/transmitter, UART) interface, a mobile industry processor interface (mobile industry processor interface, MIPI), a general-purpose input/output (general-purpose input/output, GPIO) interface, a subscriber identity module (subscriber identity module, SIM) interface, a universal serial bus (universal serial bus, USB) port, and/or the like. The USB port 130 is a port that conforms to a USB standard specification, and may be specifically a mini USB port, a micro USB port, a USB type-C port, or the like. The USB port 130 may be configured to connect to a charger to charge the electronic device, or may be configured to transmit data between the electronic device and a peripheral device, or may be configured to connect to a headset and play audio through the headset.

It may be understood that an interface connection relationship between the modules that is shown in this embodiment of the present invention is merely an example for description, and does not constitute a limitation on the structure of the electronic device. In some other embodiments of this application, the electronic device may alternatively use an interface connection manner different from that in the foregoing embodiment, or a combination of a plurality of interface connection manners.

The charging management module 140 is configured to receive a charging input from the charger. The charger may be a wireless charger, or may be a wired charger. In some embodiments of wired charging, the charging management module 140 may receive a charging input from the wired charger through the USB port 130. In some embodiments of wireless charging, the charging management module 140 may receive a wireless charging input through a wireless charging coil of the electronic device. When charging the battery 142, the charging management module 140 may further supply power to the electronic device by using the power management module 141.

The power management module 141 is configured to connect to the battery 142, the charging management module 140, and the processor 110. The power management module 141 receives an input from the battery 142 and/or the charging management module 140, and supplies power to the processor 110, the internal memory 121, the display 194, the camera 193, the wireless communications module 160, and the like. The power management module 141 may be configured to monitor parameters such as a battery capacity, a battery cycle count, and a battery state of health (electric leakage and impedance). In some other embodiments, the power management module 141 may be alternatively disposed in the processor 110. In some other embodiments, the power management module 141 and the charging management module 140 may alternatively be disposed in a same component.

A wireless communication function of the electronic device may be implemented through the antenna 1, the antenna 2, the mobile communication module 150, the wireless communication module 160, the modem processor, the baseband processor, and the like. The antenna 1 and the antenna 2 are configured to transmit and receive electromagnetic wave signals. Each antenna of the electronic device may be configured to cover one or more communication frequency bands. Different antennas may be multiplexed to improve utilization of the antennas. For example, the antenna 1 may be multiplexed as a diversity antenna of a wireless local area network. In some other embodiments, the antenna may be used in combination with a tuning switch.

The mobile communications module 150 may provide a solution that is for wireless communication including 2G/3G/4G/5G and the like and that is applied to the electronic device. The mobile communications module 150 may include at least one filter, a switch, a power amplifier, a low noise amplifier, and the like. The mobile communications module 150 may receive an electromagnetic wave through the antenna 1, perform processing such as filtering or amplification on the received electromagnetic wave, and transmit a processed electromagnetic wave to the modem processor for demodulation. The mobile communications module 150 may further amplify a signal modulated by the modem processor, and convert the signal into an electromagnetic wave through the antenna 1 for radiation. In some embodiments, at least some function modules of the mobile communications module 150 may be disposed in the processor 110. In some embodiments, at least some function modules of the mobile communications module 150 and at least some modules of the processor 110 may be disposed in a same component.

The modem processor may include a modulator and a demodulator. The modulator is configured to modulate a to-be-sent low-frequency baseband signal into a medium-high frequency signal. The demodulator is configured to demodulate a received electromagnetic wave signal into a low-frequency baseband signal. Then, the demodulator transmits the low-frequency baseband signal obtained through demodulation to the baseband processor for processing. The baseband processor processes the low-frequency baseband signal, and then transmits a processed signal to the application processor. The application processor outputs a sound signal by using an audio device (which is not limited to the speaker 170A, the receiver 170B, and the like), or displays an image or a video on the display 194. In some embodiments, the modem processor may be an independent component. In some other embodiments, the modem processor may be independent of the processor 110, and is disposed in a same component with the mobile communications module 150 or another function module.

The wireless communications module 160 may provide a wireless communication solution that includes a wireless local area network (wireless local area networks, WLAN), Bluetooth, a global navigation satellite system (global navigation satellite system, GNSS), frequency modulation (frequency modulation, FM), NFC, an infrared (infrared, IR) technology, or the like and that is applied to the electronic device. The wireless communications module 160 may be one or more components that integrate at least one communications processor module. The wireless communications module 160 receives an electromagnetic wave through the antenna 2, performs frequency modulation and filtering processing on an electromagnetic wave signal, and sends a processed signal to the processor 110. The wireless communications module 160 may further receive a to-be-sent signal from the processor 110, perform frequency modulation and amplification on the signal, and convert the signal into an electromagnetic wave through the antenna 2 for radiation.

In some embodiments, in the electronic device, the antenna 1 and the mobile communications module 150 are coupled, and the antenna 2 and the wireless communications module 160 are coupled, so that the electronic device can communicate with a network and another device by using a wireless communications technology. The wireless communications technology may include a GSM, a GPRS, CDMA, WCDMA, TD-SCDMA, LTE, a GNSS, a WLAN, NFC, FM, an IR technology, and/or the like. The GNSS may include a global positioning system (global positioning system, GPS), a global navigation satellite system (global navigation satellite system, GLONASS), a BeiDou navigation satellite system (BeiDou navigation satellite system, BDS), a quasi-zenith satellite system (quasi-zenith satellite system, QZSS), and/or a satellite based augmentation system (satellite based augmentation system, SBAS).

The electronic device may implement a display function through the GPU, the display 194, the application processor, and the like. The GPU is a microprocessor for image processing, and is connected to the display 194 and the application processor. The GPU is configured to perform mathematical and geometrical calculation, and is configured to perform graphics rendering. The processor 110 may include one or more GPUs, which execute instructions to generate or change display information.

The display 194 is configured to display an image, a video, and the like. The display 194 includes a display panel. The display panel may be a liquid crystal display (liquid crystal display, LCD), an organic light-emitting diode (organic light-emitting diode, OLED), an active-matrix organic light emitting diode or an active matrix organic light emitting diode (active-matrix organic light emitting diode, AMOLED), a flexible light-emitting diode (flexible light-emitting diode, FLED), a mini-LED, a micro-LED, a micro-OLED, a quantum dot light emitting diode LED (quantum dot light emitting diode, QLED), or the like. In some embodiments, the electronic device may include one or N displays 194, where N is a positive integer greater than 1.

The electronic device may implement a photographing function through the ISP, one or more cameras 193, the video codec, the GPU, one or more displays 194, the application processor, and the like.

The ISP is configured to process data fed back by the camera 193. For example, during photographing, a shutter is pressed, and a ray of light is transmitted to a photosensitive element of a camera through a lens. An optical signal is converted into an electrical signal. The photosensitive element of the camera transmits the electrical signal to the ISP for processing, and converts the electrical signal into a visible image. The ISP may further perform algorithm optimization on noise, luminance, and complexion of the image. The ISP may further optimize parameters such as exposure and a color temperature of a photographing scenario. In some embodiments, the ISP may be disposed in the camera 193.

The camera 193 is configured to capture a static image or a video. An optical image of an object is generated through the lens, and the image is projected to the light-sensitive element. The light-sensitive element may be a charge coupled device (charge coupled device, CCD) or a complementary metal-oxide-semiconductor (complementary metal-oxide-semiconductor, CMOS) phototransistor. The light-sensitive element converts an optical signal into an electrical signal, and then transmits the electrical signal to the ISP, so that the ISP converts the electrical signal into a digital image signal. The ISP outputs the digital image signal to the DSP for processing. The DSP converts the digital image signal into an image signal in a standard format, for example, RGB or YUV. In some embodiments, the electronic device 100 may include one or N camera 193, and N is a positive integer greater than 1.

The digital signal processor is configured to process a digital signal, and in addition to a digital image signal, may further process another digital signal. For example, when the electronic device 100 performs frequency selection, the digital signal processor is configured to perform Fourier transform and the like on frequency energy.

The video codec is configured to compress or decompress a digital video. The electronic device 100 may support one or more video codecs. In this way, the electronic device 100 may play or record videos in a plurality of encoding formats, for example, moving picture experts group (moving picture experts group, MPEG)-1, MPEG-2, MPEG-3, and MPEG-4.

The NPU is a neural-network (neural-network, NN) computing processor that processes input information rapidly by referring to a structure of a biological neural network, for example, by referring to a transmission mode between human brain neurons, and can further perform self-learning continuously. The NPU can implement applications such as intelligent cognition of the electronic device, for example, image recognition, facial recognition, voice recognition, and text understanding.

The external memory interface 120 may be configured to connect to an external storage card, for example, a micro SD card, to extend a storage capability of the electronic device. The external storage card communicates with the processor 110 through the external memory interface 120, to implement a data storage function. For example, data files such as music, photos, and videos are stored in the external storage card.

The internal memory 121 may be configured to store one or more computer programs, and the one or more computer programs include instructions. The processor 110 may run the instructions stored in the internal memory 121, so that the electronic device performs a voice switch method provided in some embodiments of this application, various function applications, data processing, and the like. The internal memory 121 may include a program storage area and a data storage area. The program storage area may store an operating system. The program storage area may further store one or more applications (for example, Gallery and Contacts), and the like. The data storage area may store data (for example, Photos and Contacts) created during use of the electronic device. In addition, the internal memory 121 may include a high-speed random access memory, and may further include a nonvolatile memory, for example, at least one magnetic disk storage device, a flash memory, and a universal flash storage (universal flash storage, UFS). In some embodiments, the processor 110 may run the instructions stored in the internal memory 121 and/or instructions stored in the memory disposed in the processor 110, so that the electronic device performs the voice switch method provided in embodiments of this application, various function applications, and data processing.

The electronic device may implement an audio function such as music playing or recording by using the audio module 170, the speaker 170A, the receiver 170B, the microphone 170C, the headset jack 170D, the application processor, and the like. The audio module 170 is configured to convert digital audio information into analog audio signal output, and is also configured to convert an analog audio input into a digital audio signal. The audio module 170 may be configured to encode and decode an audio signal. In some embodiments, the audio module 170 may be disposed in the processor 110, or some function modules of the audio module 170 are disposed in the processor 110.

The speaker 170A, also referred to as a “loudspeaker”, is configured to convert an audio electrical signal into a sound signal. The electronic device may be used to listen to music or answer a hands-free call by using the speaker 170A.

The receiver 170B, also referred to as an “earpiece”, is configured to convert an audio electrical signal into a sound signal. When a call is answered or voice information is received by using the electronic device, the receiver 170B may be put close to a human ear to receive a voice.

The microphone 170C, also referred to as a “mike” or a “mic”, is configured to convert a sound signal into an electrical signal. When making a call or sending a voice message, the user may make a sound near the microphone 170C through the mouth, to enter a sound signal to the microphone 170C. At least one microphone 170C may be disposed in the electronic device. In some other embodiments, two microphones 170C may be disposed in the electronic device, to implement a noise reduction function, in addition to collecting a sound signal. In some other embodiments, three, four, or more microphones 170C may alternatively be disposed in the electronic device, to collect a sound signal and reduce noise. The microphones may further identify a sound source, to implement a directional recording function, and the like.

The headset jack 170D is configured to connect to a wired headset. The headset jack 170D may be the USB port 130, or may be a 3.5 mm open mobile terminal platform (open mobile terminal platform, OMTP) standard interface or a cellular telecommunications industry association of the USA (cellular telecommunications industry association of the USA, CTIA) standard interface.

The sensor 180 may include a pressure sensor 180A, a gyroscope sensor 180B, a barometric pressure sensor 180C, a magnetic sensor 180D, an acceleration sensor 180E, a distance sensor 180F, an optical proximity sensor 180G, a fingerprint sensor 180H, a temperature sensor 180J, a touch sensor 180K, an ambient light sensor 180L, a bone conduction sensor 180M, and the like.

The pressure sensor 180A is configured to sense a pressure signal, and can convert the pressure signal into an electrical signal. In some embodiments, the pressure sensor 180A may be disposed on the display 194. There are many types of pressure sensors 180A, such as a resistive pressure sensor, an inductive pressure sensor, and a capacitive pressure sensor. The capacitive pressure sensor may include at least two parallel plates made of conductive materials. When force is exerted on the pressure sensor 180A, capacitance between electrodes changes. The electronic device determines strength of pressure based on a change of the capacitance. When a touch operation is performed on the display 194, the electronic device detects strength of the touch operation by using the pressure sensor 180A. The electronic device may further calculate a touch position based on a detection signal of the pressure sensor 180A. In some embodiments, touch operations that are performed at a same touch position but have different touch operation strength may correspond to different operation instructions. For example, when a touch operation whose touch operation strength is less than a first pressure threshold is performed on a Messages icon, an instruction for viewing an SMS message is executed. When a touch operation whose touch operation strength is greater than or equal to the first pressure threshold is performed on the Messages icon, an instruction for creating an SMS message is executed.

The gyroscope sensor 180B may be configured to determine a motion posture of the electronic device. In some embodiments, an angular velocity of the electronic device around three axes (namely, axes x, y, and z) may be determined by using the gyroscope sensor 180B. The gyroscope sensor 180B may be configured to perform image stabilization during photographing. For example, when a shutter is pressed, the gyroscope sensor 180B detects a jitter angle of the electronic device, calculates, based on the angle, a distance for which a lens module needs to compensate, and enables the lens to offset jitter of the electronic device through reverse motion, to implement image stabilization. The gyroscope sensor 180B may be used in a navigation scenario, a motion-sensing game scenario, and the like.

The acceleration sensor 180E may detect accelerations in various directions (usually on three axes) of the electronic device, and may detect magnitude and a direction of gravity when the electronic device is still. The acceleration sensor may be configured to recognize a posture of the electronic device, and is used in screen switching between a landscape mode and a portrait mode, a pedometer, or another application.

The distance sensor 180F is configured to measure a distance. The electronic device may measure the distance through infrared or laser. In some embodiments, in a photographing scenario, the electronic device may measure the distance by using the distance sensor 180F, to implement quick focusing.

The optical proximity sensor 180G may include, for example, a light-emitting diode (LED) and an optical detector such as a photodiode. The light-emitting diode may be an infrared light-emitting diode. The electronic device emits infrared light by using the light-emitting diode. The electronic device detects infrared reflected light from a nearby object by using the photodiode. When detecting sufficient reflected light, the electronic device may determine that there is an object near the electronic device. When detecting insufficient reflected light, the electronic device may determine that there is no object near the electronic device. The electronic device may detect, by using the optical proximity sensor 180G, that the user holds the electronic device close to an ear for a call, to automatically turn off a screen for power saving. The optical proximity sensor 180G may also be used in a leather case mode or a pocket mode to automatically unlock or lock the screen.

The ambient light sensor 180L is configured to sense ambient light brightness. The electronic device may adaptively adjust brightness of the display 194 based on the sensed brightness of the ambient light. The ambient light sensor 180L may also be configured to automatically adjust a white balance during photographing. The ambient light sensor 180L may further cooperate with the optical proximity sensor 180G to detect whether the electronic device is in a pocket, so as to avoid an unintentional touch.

The fingerprint sensor 180H (also referred to as a fingerprint recognizer) is configured to collect a fingerprint. The electronic device may use a feature of the collected fingerprint to implement fingerprint-based unlocking, application lock access, fingerprint-based photographing, fingerprint-based call answering, and the like. In addition, for other records about the fingerprint sensor, refer to the international patent application PCT/CN2017/082773 entitled “NOTIFICATION PROCESSING METHOD AND ELECTRONIC DEVICE”, which is incorporated in embodiments of this application by reference in its entirety.

The touch sensor 180K is also referred to as a “touch panel”. The touch sensor 180K may be disposed on the display 194, and the touch sensor 180K and the display 194 form a touchscreen, which is also referred to as a “touch screen”. The touch sensor 180K is configured to detect a touch operation performed on or near the touch sensor. The touch sensor may transfer the detected touch operation to the application processor to determine a type of a touch event. A visual output related to the touch operation may be provided on the display 194. In some other embodiments, the touch sensor 180K may alternatively be disposed on a surface of the electronic device, and is located at a position different from that of the display 194.

The bone conduction sensor 180M may obtain a vibration signal. In some embodiments, the bone conduction sensor 180M may obtain a vibration signal of a vibration bone of a human vocal-cord part. The bone conduction sensor 180M may contact a human pulse, and receive a blood pressure beating signal. In some embodiments, the bone conduction sensor 180M may alternatively be disposed in a headset, to obtain a bone conduction headset. The audio module 170 may obtain a voice signal through parsing based on the vibration signal, of the vibration bone of the vocal-cord part, that is obtained by the bone conduction sensor 180M, to implement a voice function. The application processor may parse heart rate information based on the blood pressure beating signal obtained by the bone conduction sensor 180M, to implement a heart rate detection function.

The button 190 includes a power button, a volume button, and the like. The button 190 may be a mechanical button, or may be a touch button. The electronic device may receive a button input, and generate a button signal input related to user settings and function control of the electronic device.

The motor 191 may generate a vibration prompt. The motor 191 may be used for an incoming call vibration prompt, or may be used for a touch vibration feedback. For example, touch operations performed on different applications (for example, photographing and audio playing) may correspond to different vibration feedback effects. For touch operations performed on different areas on the display 194, the motor 191 may also correspond to different vibration feedback effects. Different application scenarios (for example, a time prompt, information receiving, an alarm clock, and a game) may also correspond to different vibration feedback effects. A touch vibration feedback effect may be customized.

The indicator 192 may be an indicator light, and may be configured to indicate a charging status and a power change, or may be configured to indicate a message, a missed call, a notification, and the like.

The SIM card interface 195 is used to connect to a SIM card. The SIM card may be inserted into the SIM card interface 195 or removed from the SIM card interface 195, to implement contact with or be separated from the electronic device. The electronic device may support one or N SIM card interfaces, where N is a positive integer greater than 1. The SIM card interface 195 can support a nano-SIM card, a micro-SIM card, a SIM card, and the like. A plurality of cards may be simultaneously inserted into a same SIM card interface 195. The plurality of cards may be of a same type, or may be of different types. The SIM card interface 195 is compatible with different types of SIM cards. The SIM card interface 195 may also be compatible with the external storage card. The electronic device interacts with a network by using the SIM card, to implement functions such as calling and data communication. In some embodiments, the electronic device uses an eSIM, namely, an embedded SIM card. The eSIM card may be embedded into the electronic device, and cannot be separated from the electronic device.

The following describes display forms of a foldable phone and screen display situations in the display forms.

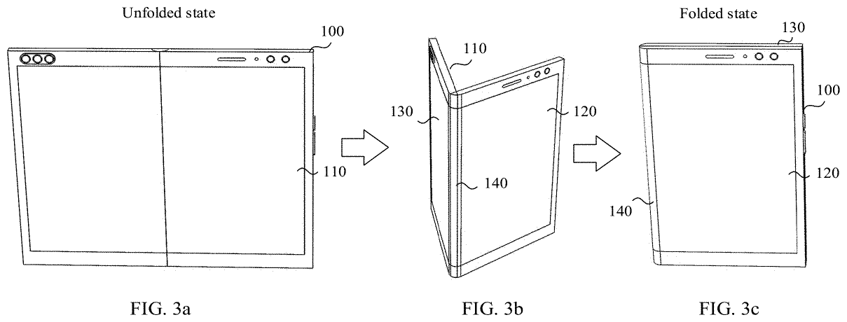

FIG. 3a to FIG. 3c are a schematic diagram of a physical structure of a mobile phone 100. As shown in FIG. 3a, the mobile phone 100 in an unfolded state has two large planes. The two large planes are disposed opposite to each other. A screen 110 is disposed on one plane, and a screen 120, a screen 130, and a sidebar 140 (or may be referred to as a side area) located between the screen 120 and the screen 130 are disposed on the other opposite plane. In some embodiments, the sidebar 140 may be a flexible display.

In this case, as shown in FIG. 3a, when the mobile phone 100 is in the unfolded state, the screen 110 displays content and responds to a user operation, and the screen 120 and the like on the plane of the other side do not work. For example, the screen 120 neither displays content nor responds to a user operation.

When the mobile phone 100 is folded towards the middle along a central axis of the screen 110, which is similar to a manner of folding a book page, the mobile phone 100 presents a posture shown in FIG. 3b in this process. In this case, an included angle between the screen 120 and the screen 130 is less than 180° and greater than 0°. When the mobile phone 100 is in this posture, the screen 110 is folded, and the screens such as the screen 120 on the plane of the outer side may start to work. In this case, one or more of the screen 120, the screen 130, and the screen 140 may work. For example, the screen 120 may be turned on and display content, and the screen 120 may implement some functions in response to a touch control operation performed by a user. A work manner of the screen in the posture shown in FIG. 3b is not particularly limited in this embodiment of this application.

In a posture shown in FIG. 3c, after the screen 110 is totally folded, the screen 120 and the screen 130 are located on planes of two opposite sides. In this case, it may be considered that the screen 120 and the screen 130 are parallel, and an included angle between the screen 120 and the screen 130 is 0. When the mobile phone 100 is in the posture, the mobile phone 100 may display content and respond to a user operation on the screen 120 or the screen 130. For example, the screen 120 may be specified to display content and respond to a user operation. For another example, a camera disposed on the mobile phone 100 may be considered. After the mobile phone 100 is folded, and the camera located on the same plane as the screen 120 captures a user profile picture, the screen 120 is turned on, and the screen 120 displays content and responds to a user operation.

It should be noted that, in some possible embodiments, the posture shown in FIG. 3b may also be considered as a folded state. In this embodiment of this application, the folded state of the mobile phone 100 may include the posture shown in FIG. 3b and the posture shown in FIG. 3c.

A size of the screen 120 may be the same as or different from a size of the screen 130 in the mobile phone 100. In an embodiment, if the size of the screen 120 is different from the size of the screen 130, a screen with a larger screen size may be used as a primary screen, and the other screen may be used as a secondary screen. For example, if the size of the screen 130 is greater than the size of the screen 120, the screen 130 may be the primary screen, and the screen 120 is the secondary screen. Alternatively, when the size of the screen 120 is the same as the size of the screen 130, one of the screens may be used as a primary screen, and the other screen may be used as a secondary screen. For example, the screen 130 is the secondary screen, and the screen 120 may be the primary screen.

After the primary screen is specified and the mobile phone 100 is folded, the primary screen is usually turned on, and the primary screen displays content and responds to a user operation. In addition, in some embodiments, after the mobile phone 100 is folded, the secondary screen is turned on, and the secondary screen displays content and responds to a user operation.

In addition, if the sidebar 140 is the flexible display, when the mobile phone 100 is in the folded state, the sidebar 140 may also be turned on, display content, and respond to a user operation. For example, in a scenario in which the screen 120 is turned on in the folded state, the sidebar 140 and the screen 120 may be used as one screen to display content, for example, display a launcher (Launcher) in a screen area shown by the sidebar 140 and the screen 120. Alternatively, the sidebar 140 and the screen 120 may separately and independently display content. For example, the screen 120 may display launcher content, and the sidebar 140 may display a virtual volume button, so as to increase or decrease volume in response to a touch control operation performed by the user. Alternatively, when the mobile phone 100 is in the folded state, the sidebar 140 may not be turned on or display content, but may perform a preset function in response to a user operation. Details are described subsequently. Alternatively, the sidebar 140 may not work, that is, the sidebar 140 is not turned on, does not display content, and does not respond to a user operation.

The following separately describes a screen display manner of the mobile phone 100 in the folded state and a screen display manner of the mobile phone 100 in the unfolded state.

1. The Mobile Phone is in the Folded State

In this embodiment of this application, when the mobile phone 100 is in the folded state, if a difference between the length and the width of a screen is large, for example, a length-width ratio is greater than 21:9, the screen may be split into two or more areas, so that a size of one screen area obtained through split can adapt to a display size of an application, and the screen area is used to display content of the application.

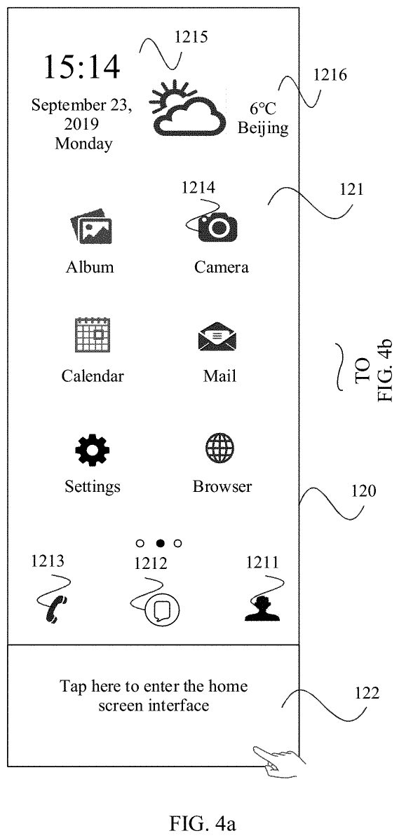

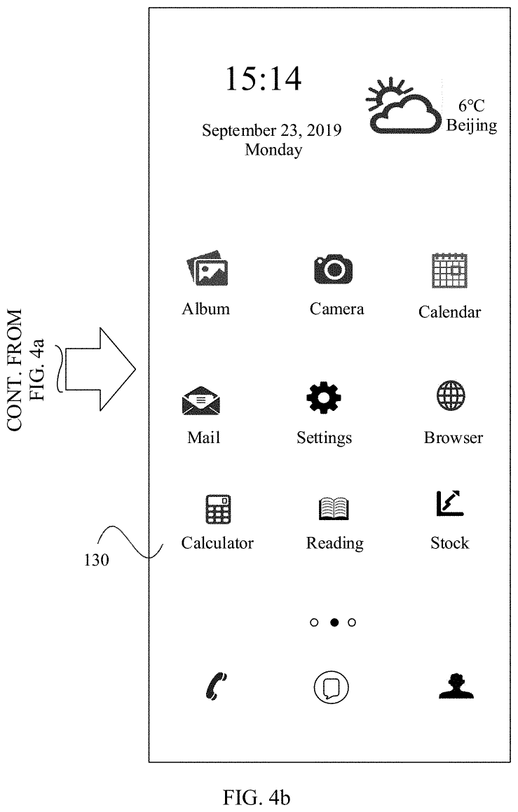

For example, FIG. 4a and FIG. 4b are a schematic diagram of display interfaces of a mobile phone 100 in a folded state. In this scenario, a screen 130 with a large size may be used as a primary screen, and a screen 120 with a small size is used as a secondary screen. A length-width ratio of the screen 130 falls within a range of 4:3 to 21:9, but a length-width ratio of the screen 120 is greater than 21:9, and the screen 120 may be considered as an ultra-long screen. Therefore, when the mobile phone 100 displays content on the screen 120, as shown in an interface in FIG. 4a, the screen 120 may be split into two display areas: a screen 121 and a screen 122.

The screen 121 displays launcher content. For example, the screen 121 may display an icon of an application, for example, display a Contact icon 1211, a Messages icon 1212, and a Phone icon 1213. For another example, the screen 121 may further display an icon and a name of an app. For example, an icon control 1214 of a camera application displays an icon and a name of the app. For another example, the screen 121 further displays a time control 1215 and a weather control 1216. In this embodiment of this application, a launcher displayed on the screen 121 may be set by default in the mobile phone 100, or may be customized by a user. Therefore, content displayed on the launcher and a display format on the launcher are not limited.

A length-width ratio of the screen 121 falls within the range of 4:3 to 21:9. This can meet a requirement for normal display of the launcher content, reduce a problem such as a display conflict or application freezing due to a mismatched length-width ratio, and have good user experience.

The screen 122 may be used as an entry for screen switching. In the interface shown in FIG. 4a, a prompt “Tap here to enter the home screen interface” may be displayed to the user on the screen 122. Therefore, if the user taps the screen 122, the screen 130 is turned on and the screen 130 displays the launcher content and responds to a user operation, and the screen 120 is tuned off, and is in a blank screen state or a screen-off state. In this embodiment of this application, in addition to tapping the screen 122, another touch control operation, for example, touching and holding, double tapping, sliding, or drawing a specified gesture (for example, drawing a “C” type) may be used. This is not particularly limited in this embodiment of this application. In this way, the user can easily implement screen switching (switching from the screen 120 to the screen 130) through the touch control operation performed on the screen 122, which is simple and convenient, and has good user experience.

When the mobile phone 100 is switched to the screen 130 and the screen 130 starts to work, the length-width ratio of the screen 130 can meet display requirements of the application and the launcher. Therefore, screen splitting may not be performed on the screen 130. As shown in an interface in FIG. 4b, the screen 130 displays the launcher content.

In this way, the screen 120 is split into the screen 121 and the screen 122, which can effectively improve screen resource utilization, facilitate a user operation and use, and also help improve use experience.

It should be noted that, in this embodiment of this application, that the screen 120 is split into the screen 121 and the screen 122 indicates that the screen 121 and the screen 122 are independent of each other in terms of actual content, a response rule, and the like, and the screen 121 and the screen 122 are two independent display areas. However, in this embodiment of this application, the screen 120 is not physically split, and the screen 121 and the screen 122 belong to the same physical screen 120.

In this embodiment of this application, the screen 121 may display content displayed in an application. The screen 122 may also display other content, to implement another function.

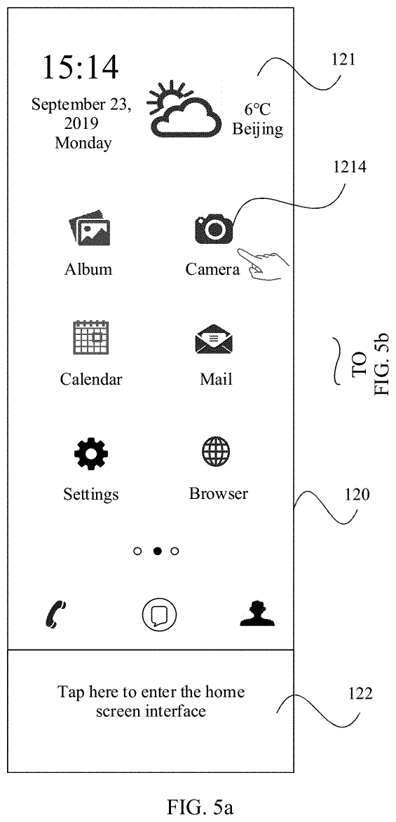

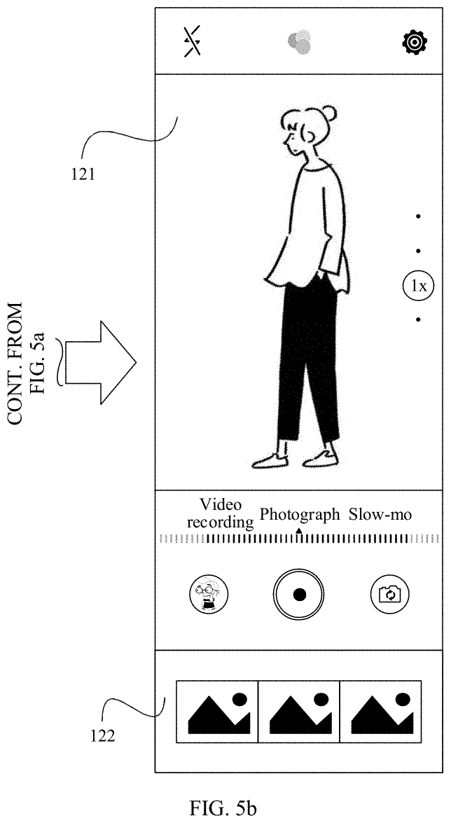

For example, in another possible embodiment, FIG. 5a and FIG. 5b are a schematic diagram of other display interfaces of a mobile phone 100 in a folded state. In an interface shown in FIG. 5a, a screen 120 is in an on state. In this case, the screen 120 is split into two display areas. A screen 121 is a display interface of a launcher, and displays launcher content. A screen 122 is used as an entry for screen switching, and may switch from the screen 120 to a screen 130 in response to a touch control operation performed by a user.

In the interface shown in FIG. 5a, the user taps an icon control 1214 of a camera application, and the mobile phone 100 may display a display interface of the camera application in response to the touch control operation, as shown in an interface in FIG. 5b. In the interface shown in FIG. 5b, the screen 121 displays the display interface of the camera application, and specifically, a preview picture of an image currently captured by a camera of the mobile phone 100 and controls in the camera application. The user may perform a touch control operation in the camera interface to complete actions such as photographing, video recording, and slow-mo video recording. In addition, the user may further adjust the camera, view an album, and set the camera. The display interface (the content in the display area of the screen 121) of the camera application is an example, and should not be construed as a limitation on this embodiment of this application. In an actual scenario, more or less content may be displayed in the display interface of the camera application.

Specifically, one or more images recently captured by the user may be displayed on the screen 122 in the interface shown in FIG. 5b. For example, three images recently captured by the user are displayed in the interface shown in FIG. 5b. Therefore, when the user photographs or records a video in the camera application, the mobile phone 100 can automatically display the image recently captured by the user on the screen 122, and the user can preview the image on the screen 122. Compared with a manner in which the user opens a gallery after photographing, finds an image and taps the image for large image preview, the technical solution provided in this embodiment of this application is more convenient, and helps improve photographing experience of the user.

In addition, the screen 122 in the interface shown in FIG. 5b may further display another shortcut related to the camera application. For example, when slow-mo video recording is performed in the camera application, the screen 122 may display a motion detection control for the slow-mo video recording. In this way, the user can tap the motion detection control to enable or disable an automatic recording function for the slow-mo video recording. For another example, when photographing is performed in the camera application, the screen 122 may further display shortcuts of a plurality of photographing functions, for example, may display one or more of a control used for photographing a panorama image, a control used for time-lapse, and a control used for photographing an image of a specific shape (for example, a circle or a square).

It may be understood that, in the scenario shown in FIG. 5a and FIG. 5b, when the mobile phone 100 displays a display interface of a specific application on the screen 121, the screen 122 may display a shortcut related to the application (the application displayed on the screen 121). In this case, different types of applications may have different shortcuts related to the applications. For example, when the screen 121 displays content of an album application, the screen 122 may display one or more albums in the album application. In this way, the user can tap any album to switch content displayed on the screen 121. For another example, when the screen 121 displays a control of a Contacts application, the screen 122 may display a control for performing a shortcut in a contact list, for example, a control for grouping contacts or a control for creating a contact. When the user selects a contact on the screen 121, the screen 122 may display one or more of the following controls: a control for making a call, a control for sending a message, a control for editing information about the contact, and the like.

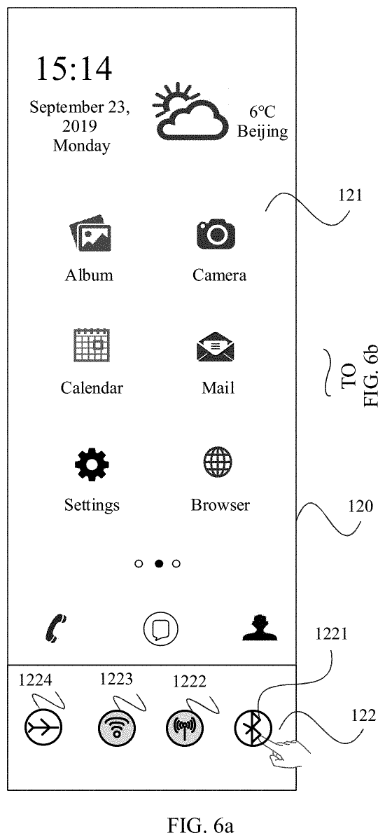

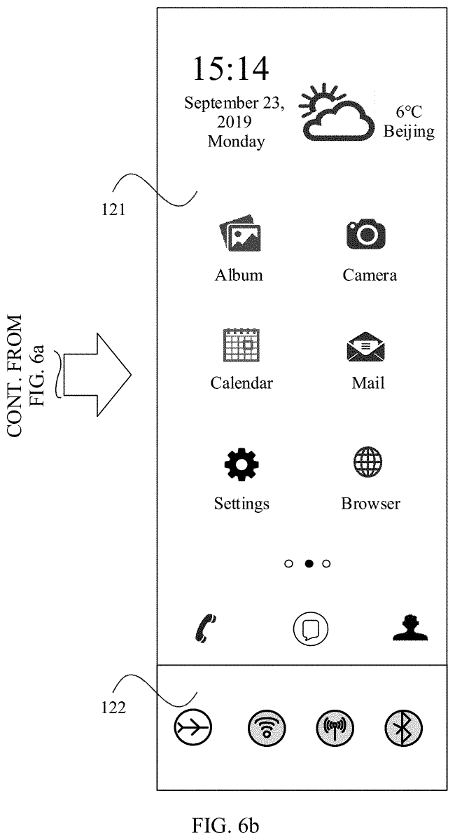

In addition, when the mobile phone 100 displays a display interface of a specific application on the screen 121, content displayed on the screen 122 may also be irrelevant to the application displayed on the screen 121. For example, the screen 121 may display a display interface of a camera application, and the screen 122 may be used as a screen switching control to switch from the screen 120 to the screen 130 in response to a user operation. For another example, the screen 121 may be a display interface of a Browser application, and the screen 122 may display icons of some applications. For another example, the screen 121 displays launcher content, and the screen 122 may display some shortcuts of setting in the mobile phone, for example, as shown in FIG. 6a and FIG. 6b.

FIG. 6a and FIG. 6b are a schematic diagram of other display interfaces of a mobile phone 100 in a folded state. In an interface shown in FIG. 5a, a screen 120 is in an on state. In this case, a screen 121 is a display interface of a launcher, and a screen 122 displays switch controls of some shortcuts in the mobile phone 100. These switch controls may be used to enable or disable some functions of the mobile phone 100 in response to a touch control operation performed by a user.

For example, FIG. 6a and FIG. 6b show four switch controls, which are a switch control 1221 used for enabling or disabling a Bluetooth function, a switch control 1222 used for enabling or disabling a cellular mobile network, a switch control 1223 used for enabling or disabling a wireless network, and a switch control 1224 used for enabling or disabling an airplane mode. It may be understood that in an actual scenario, the screen 122 may display more or fewer switch controls. For example, the screen 122 may further display a switch control used for enabling or disabling a dark mode (a work mode in which the mobile phone 100 displays content in a dark color). For another example, the screen 122 may further display a switch control used for controlling screen locking. For another example, the screen 122 may further display a switch control used for enabling or disabling a personal hotspot. No exhaustive examples are provided herein.

In this case, as shown in FIG. 6a, a current state of Bluetooth on the screen 122 is a disabled state. When the user wants to enable the Bluetooth function, for example, when the user wants to view heart rates or body temperature data recorded by a wearable device such as a smartwatch, but the data can be viewed on the mobile phone only after the data recorded in the wearable device is synchronized via Bluetooth, in this case, the user may tap the switch control 1221, and the mobile phone 100 may present an interface shown in FIG. 6b in which the Bluetooth function is enabled. Certainly, when the user taps the switch control 1221 again, the Bluetooth function of the mobile phone 100 may be disabled. The user may also perform a touch control operation on another switch control to enable or disable a response function. Details are not described. In this way, the user can conveniently control enabling or disabling of a function of the mobile phone through a simple touch control operation performed on the screen 122, which has high control experience.

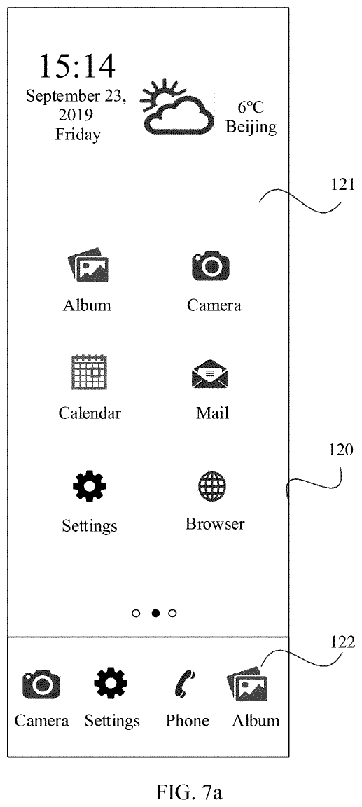

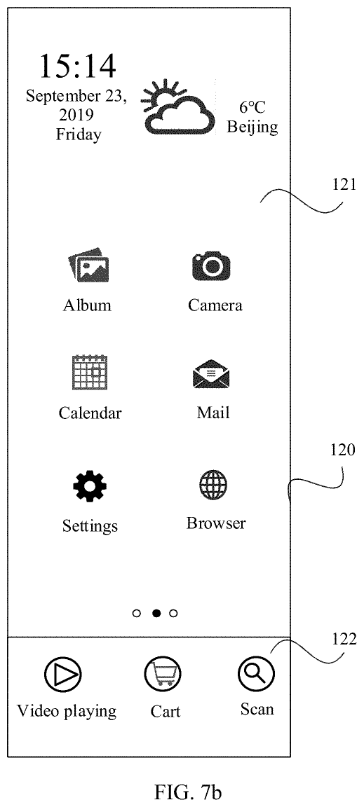

In addition, FIG. 7a and FIG. 7b are a schematic diagram of other two display interfaces of a mobile phone 100 in a folded state.

In an interface shown in FIG. 7a, a screen 121 is a display interface of a launcher, and a screen 122 displays icon controls of some applications. For example, there are four icon controls in the interface shown in FIG. 7a. A user may perform a touch control operation on an icon control on the screen 122, to start a corresponding application. For example, the user may tap an icon control of an album application, so as to display content of the album application on the screen 121.

The icon control of the application displayed on the screen 122 may be customized by the mobile phone 100, or may be customized by the user.

In an embodiment of this application, the icon control displayed on the screen 122 may be set by default in the mobile phone 100. For example, an icon control of a settings application may be displayed on the screen 122 by default.

In another embodiment of this application, the icon control displayed on the screen 122 may be icon controls of one or more applications being opened by the user most frequently in a first time interval, for example, in a last week. For example, the mobile phone 100 may record quantities of times that the user starts the applications in a last month. In this way, the screen 122 displays icon controls of the top one or more applications ranked in descending order of the quantities of times. In this case, the icon controls displayed on the screen 122 may be ranked in descending order of the quantities of opened times for display, or may be randomly displayed without any order. This is not limited in this embodiment of this application. A specified time interval may be set by default in the mobile phone 100 or customized by the user. For example, the user may tap an icon control of settings (displayed on both the screen 121 or the screen 122), and select, in a setting interface, a setting control used for setting the screen 122, so as to set or adjust the specified time interval in the setting interface on the screen 122.

In another embodiment of this application, the icon control displayed on the screen 122 may be icon controls of the top one or more applications ranked in descending order of duration of being used by the user in a second time interval, for example, in a last week. In this case, the screen 122 displays the icon controls of the one or more applications being used by the user for long duration, so that the user can use the application again. The first time interval may be the same as or different from the second time interval. The first time interval and the second time interval may be set by default in the mobile phone 100, or may be customized by the user. Details are not described.

In another embodiment of this application, the user may further drag an icon control displayed on the screen 121 to the screen 122, to display the icon control on the screen 122. For example, in the interface shown in FIG. 7a, the user may select an icon control of a settings application, and drag the setting icon control to an area in which the screen 122 is located, so that the screen 122 can display the setting icon control. In this case, the screen 121 may still display the setting icon control; or the screen 121 may no longer display the setting icon control after the drag operation. In this way, the user can conveniently add an icon control of an application to the screen 122, which provides greater flexibility for the user to use the mobile phone 100, and is more convenient for the user to use the mobile phone.

At least two of the foregoing embodiments may be used in combination. For example, in the interface in FIG. 7a, a camera application may be an application being opened by the user most frequently in last three days, and therefore the screen 122 displays an icon control of the camera application; a settings application may be a fixed application that is to be displayed on the screen 122 by default in the mobile phone 100, and therefore the screen 122 displays a setting icon control; an icon control of a phone application may be dragged by the user from the screen 121 to the screen 122; and an album application is an application with the longest accumulated duration (or single use duration) among applications being used by the user in a last week and recorded in the mobile phone 100, and therefore the screen 122 also displays an album icon control.

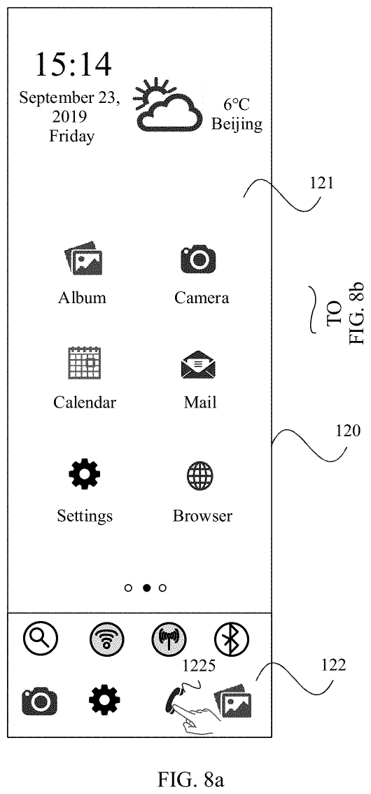

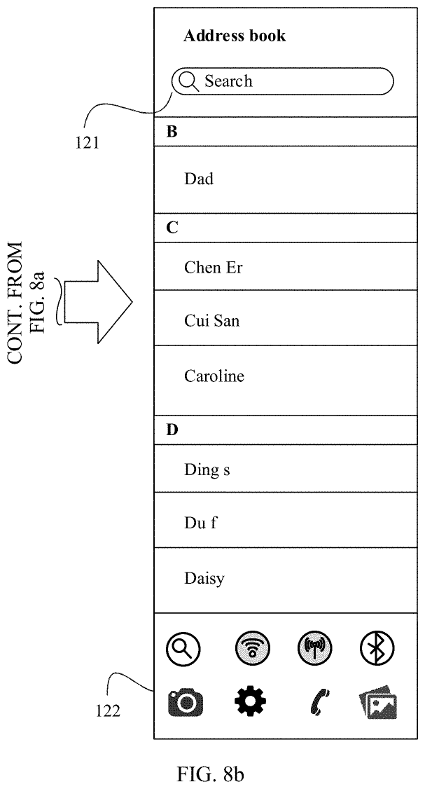

In addition, it should be noted that an icon control of any application displayed on the screen 122 may include at least one of an application icon and an application name. For example, in the interface shown in FIG. 7a, an icon control is displayed with an application icon and an application name; and in an interface shown in FIG. 8b, an icon control displayed on a screen 122 may include only an application icon. Different display manners may be fixedly set by default in the mobile phone 100, or may be automatically adjusted by the mobile phone 100 based on a quantity of controls to be displayed on the screen 122. The interface shown in FIG. 7a is used as an example. When the screen 122 displays icon controls of four applications, application names and application icons of the applications may be displayed. When the screen 122 displays icon controls of eight applications, only application names or application icons of the applications may be displayed.

An owner of an application installed on the mobile phone 100 is not particularly limited in this embodiment of this application. The application may be an application installed by default by a manufacturer to which the mobile phone 100 belongs, or may be a third-party application.

In an interface shown in FIG. 7b, the screen 121 is a display interface of a launcher, and the screen 122 displays a function control of a shortcut (Shortcut) in an application. For example, the screen 122 displays a function control used for starting a video application and playing a video, a function control used for starting a shopping application and opening a cart, and a function control used for starting a code scanning function. In addition, a function control used for starting a music app to implement a music playing function, and the like may be related.

Descriptions are provided by using a code scanning function as an example. The user may tap the function control of the code scanning function, so that the mobile phone 100 enables a two-dimensional code (and/or barcode) scanning function of a camera in response to the touch control operation. Further, the mobile phone 100 may further identify the scanned two-dimensional code, so as to complete, based on the two-dimensional code, functions such as link opening, friend adding, payment, payment collection, and search. The code scanning function may be a function provided by the camera, or may be a function provided by a third-party application on the mobile phone 100. For example, some third-party applications provide a “Scan” function. Likewise, a video application and a shopping application may also be applications built in the mobile phone 100 or functions provided by a third-party application.

Specifically, setting of a function control may also be designed by the mobile phone based on a customized design of the user, or may be selected by the user. For example, the function control displayed in the function area may include at least one of the following: the top one or more function controls ranked in descending order of quantities of times of being opened by the user in a third time interval; the top one or more function controls ranked in descending order of duration of being used by the user in a fourth time interval; one or more function controls specified by the user; or a function control fixedly set in the mobile phone 100. Details are not described.

In this embodiment of this application, the screen 122 may further display combined content of the foregoing embodiments. For example, this case is shown in FIG. 8a and FIG. 8b.

FIG. 8a and FIG. 8b are a schematic diagram of other display interfaces of a mobile phone 100 in a folded state. As shown in an interface in FIG. 8a, a screen 121 may be a display interface of a launcher, and a screen 122 displays a plurality of controls including an icon control used for enabling a code scanning function, a switch control used for enabling or disabling a mobile phone function (a Wi-Fi function, a cellular mobile network function, or a Bluetooth function), and an icon control used for starting an application (a camera application, a settings application, a phone application, or an album application).

In an actual scenario, the screen 122 may further present the controls on a plurality of control pages based on types of the controls, and control types on any control page are the same. For example, the screen 122 may include four control pages. A first control page is shown in FIG. 4a, and the screen 122 may be switched in response to a touch control operation performed by a user. A second control page is shown in FIG. 6a and FIG. 6b, and the screen 122 may present one or more switch controls. A third control page may be shown in the interface shown in FIG. 7a, and the screen 122 may present icon controls of one or more applications. A fourth control page may be shown in the interface shown in FIG. 7b, and the screen 122 may present icon controls of shortcuts of one or more applications. In this embodiment, the user may slide left or right on the screen 122 to switch between different control pages.

As shown in FIG. 8a and FIG. 8b, when the user taps an icon control of any application on the screen 122, the mobile phone 100 starts or opens the application, and presents display content of the application on the screen 121. As shown in FIG. 8a, the user taps an icon control 1225, and the screen 121 displays a contact list, as shown in an interface in FIG. 8b. In this way, the mobile phone 100 can make a call, send a message, or edit information about a contact in response to a further touch control operation performed by the user. In the interface shown in FIG. 8b, the screen 122 may still display the controls in the interface shown in FIG. 8a, or may display controls of some shortcuts related to the phone application.

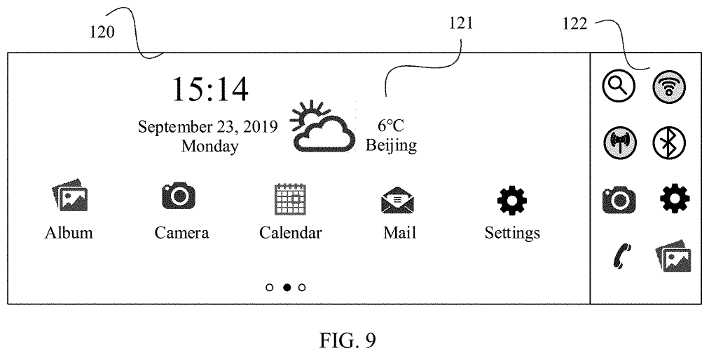

When a mobile phone 100 is in a folded state and performs landscape display, a screen 120 may also be split into a screen 121 and a screen 122, which separately display content and respond to a touch control operation performed by a user, as shown in FIG. 9.

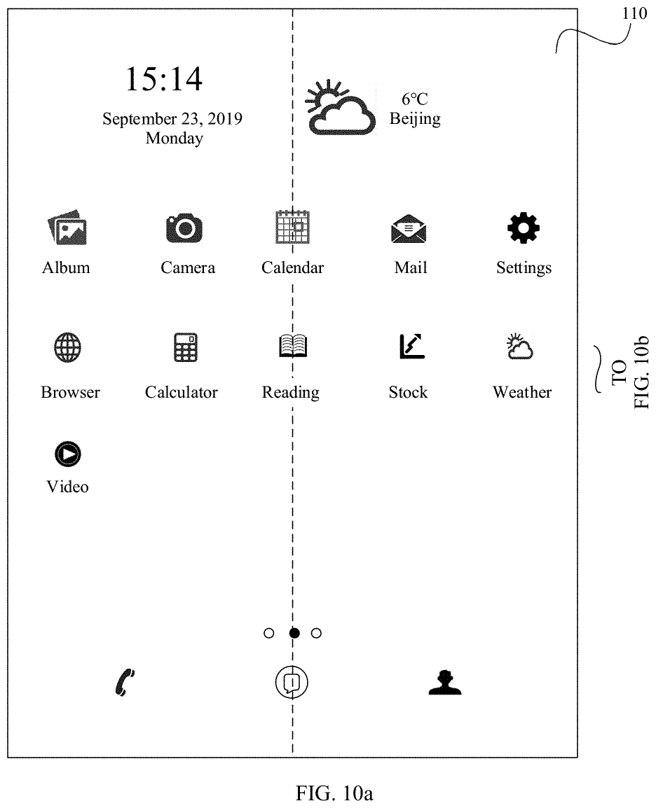

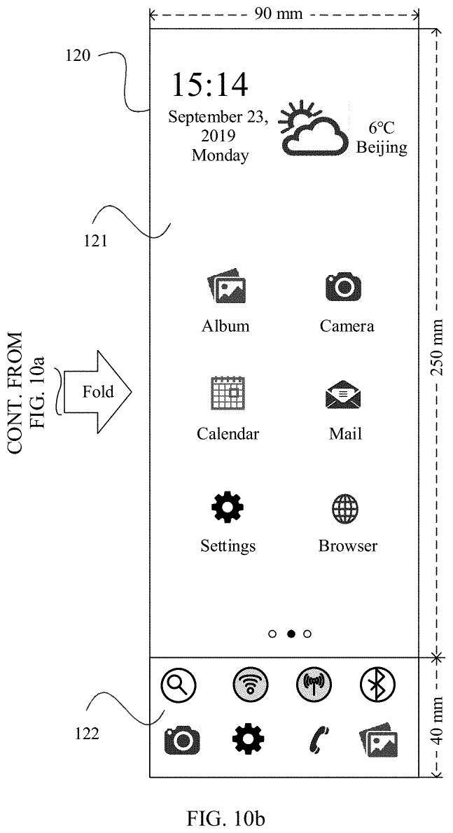

For example, FIG. 10a and FIG. 10b are a schematic diagram of switching a mobile phone 100 from an unfolded state to a folded state. When the mobile phone is in the unfolded state, a screen 110 displays content. When a user folds the mobile phone, the screen 110 is turned off, and a screen 120 may be turned on to work. In this case, on the screen 120, a screen 121 displays launcher content, and a screen 122 displays icon controls and/or switch controls. In addition, a length-width ratio of the screen 121 is 21:9, a length-width ratio of the screen 122 is 9:4, and both fall within a range of 4:3 to 21:9 and adapt to display requirements of a current application and a current launcher. It may be understood that FIG. 10a and FIG. 10b are merely examples. In an interface shown in FIG. 10b, the screen 122 may display any content described above. Details are not described herein again.

It should be noted that, when the sidebar 140 is a flexible display, and the sidebar 140 and the screen 120 are used as an entire screen to display content, in any one of the foregoing embodiments, a length-width ratio of the screen 120 needs to be comprehensively considered with reference to the width of the sidebar 140. For example, if the width of the screen 120 is 85 mm, the length of the screen 120 is 250 mm, and the width of the sidebar 140 is 5 mm, the width of the entire screen including the screen 120 and the sidebar 140 is 90 mm, a length-width ratio of the entire screen is greater than 21:9, and the screen 120 is split into the screen 121 and the screen 122.

2. The Mobile Phone is in the Unfolded State.

When the mobile phone 100 is in the unfolded state, the screen 110 displays content.

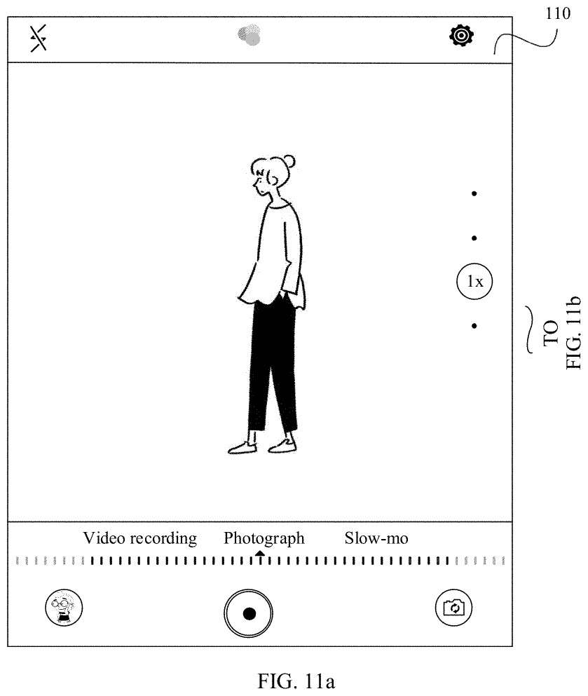

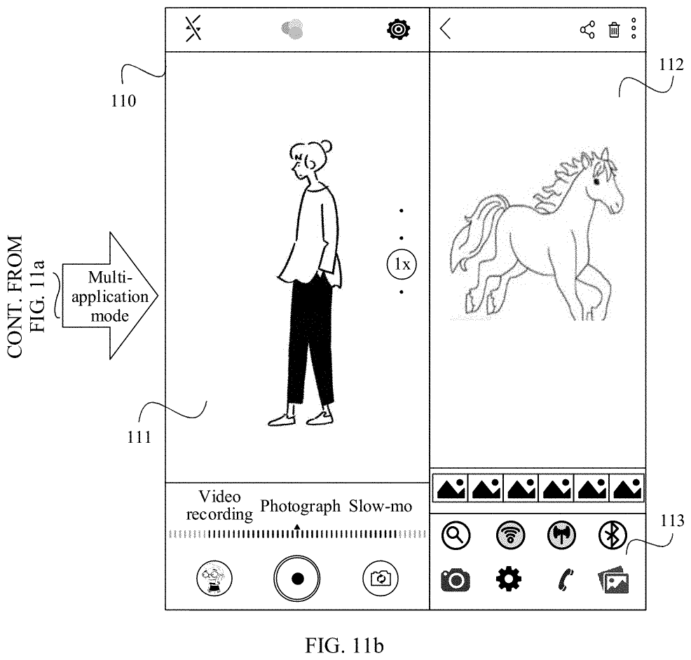

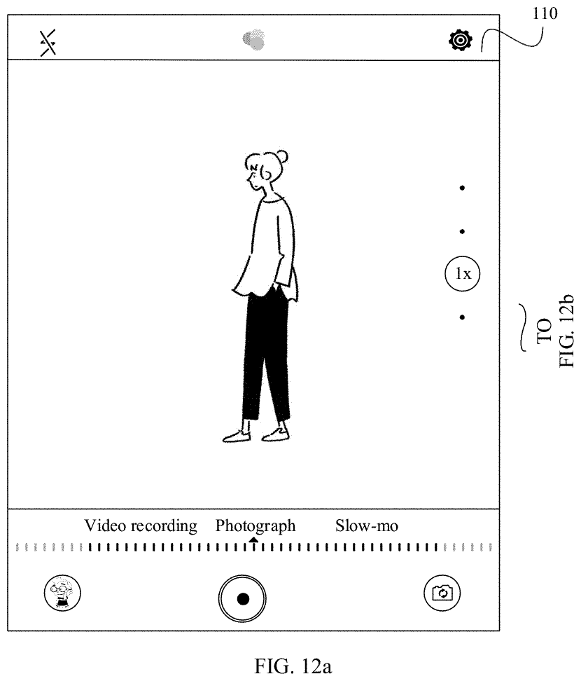

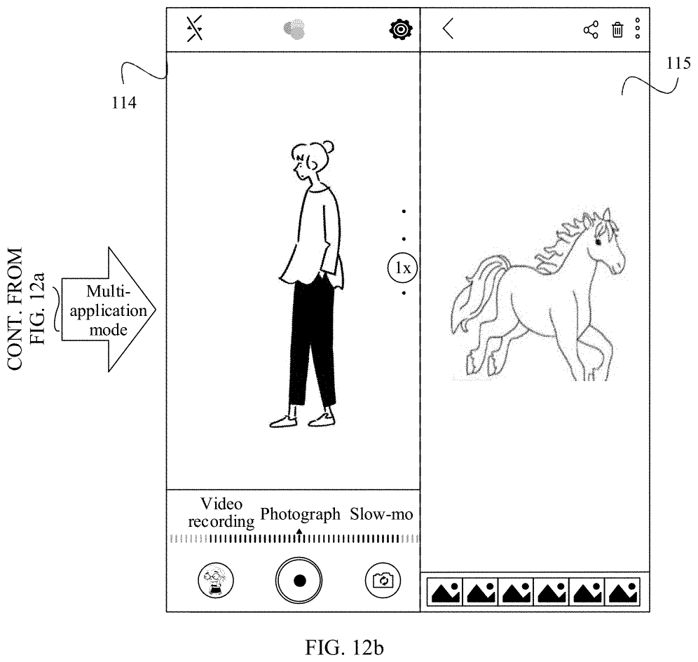

In this case, the mobile phone 100 may further have a multi-application mode. That is, one screen displays content of a plurality of applications. For example, FIG. 11a to FIG. 12b are a schematic diagram of display interfaces of a mobile phone 100 in an unfolded state.

The mobile phone 100 is currently in the unfolded state. In this case, an entire screen of a screen 110 may display content. Specifically, the entire screen of the screen 110 may display launcher content, and application content. For example, in interfaces shown in FIG. 11a and FIG. 12a, content currently displayed on the screen 110 is a display interface of a camera application.

When the mobile phone 100 is in a multi-application mode, an interface shown in FIG. 11b or FIG. 12b may be displayed, and the display interface of the camera application and a display interface of an album application are displayed on the screen 110 at the same time.

In a possible embodiment, refer to the interface shown in FIG. 11b. In the interface, the screen 110 is split into three display areas: a screen 111, a screen 112, and a screen 113. The screen 111 is the display interface of the camera application, the screen 112 is the display interface of the album application, and the screen 113 is an application area used to display icon controls and/or switch controls. In this case, for content displayed on the screen 113, refer to the manner described in any one of the foregoing embodiments in FIG. 5a to FIG. 8b. Details are not described herein again.

In the interface shown in FIG. 11b, the width of the screen 111 and the width of the screen 112 are different, and the width of the screen 111 is larger. In this case, the screen 111 may be used as a primary screen of a current display interface, and the screen 112 is used as a secondary screen of the current display interface. A length-width ratio of the screen 111 falls within a range of 4:3 to 21:9, and can adapt to a display ratio of a launcher content or application content. No screen for a function area needs to be additionally disposed. However, a length-width ratio of an entire area covered by the screen 112 and the screen 113 exceeds 21:9. In this case, the area is split into the screen 112 and the screen 113, so as to meet a display requirement of an application, make full use of screen resources, and improve screen resource utilization.

In another possible embodiment of this application, refer to the interface shown in FIG. 12b. In this interface, the screen 110 is equally split into two display areas: a screen 114 and a screen 115. Sizes of the screen 114 and the screen 115 are the same, and both can meet the length-width ratio range of 4:3 to 21:9. Therefore, no function area needs to be additionally disposed. In this case, the screen 114 may display a display interface of an application such as a camera application, and the screen 115 displays a display interface of another application such as an album application.

In this embodiment of this application, the mobile phone 100 may present a plurality of applications in any manner shown in FIG. 11b or FIG. 12b. Specifically, a multi-application presentation manner to be used may be set by default in the mobile phone 100, or may be manually set by the user. For example, in a setting interface, the mobile phone 100 may provide a setting control of the multi-application mode. In this way, a user can tap the setting control to enter a setting interface of the multi-application mode, so as to output a selection control of the multi-application presentation manner in the setting interface. Therefore, the user can perform a touch control operation on the selection control, to set the multi-application presentation manner for the mobile phone. For example, if the user selects equal presentation, when the multi-application mode is triggered, content of the plurality of applications is presented in the manner shown in FIG. 12b. For another example, if the user selects unequal presentation, when the multi-application mode of the mobile phone is triggered, content of the plurality of applications is presented in the manner shown in FIG. 11b.

There may be a plurality of manners for triggering the mobile phone 100 to enter the multi-application mode. This is not limited in this embodiment of this application.

For example, a dock bar may be hidden on a side of the screen 110. When a finger of the user slides from the side to the screen, the dock bar is called out. In this way, the user can perform a touch control operation on an application displayed on the dock bar, to open another application. In this case, the mobile phone 100 enters the multi-application mode in response to the touch control operation performed by the user on the application displayed on the dock bar.

For another example, the mobile phone 100 may enter the multi-application mode in response to a specified operation performed by the user, for example, touching and holding in a special area, or drawing a specified gesture (for example, drawing a C shape). For example, in the interface shown in FIG. 12a, the user may draw a C shape to trigger the mobile phone 100 to enter the multi-application mode. In this case, the screen 114 still displays the display interface of the current camera application, and the screen 115 may display a launcher. When the user taps the launcher to start another application, for example, the album application, the screen 115 displays the display interface of the album application, as shown in the interface in FIG. 12b.

For another example, the screen 110 of the mobile phone 100 may further display a floating window of an application. In response to an operation of dragging, performed by the user, the floating window to a specified position, for example, to a preset area on the right side of the screen, the multi-application mode is triggered, and the mobile phone 100 presents the interface shown in FIG. 11b or FIG. 12b.

A case in which the mobile phone 100 implements the multi-application mode in the manner of the interface shown in FIG. 11b is further described herein. In this case, when the screen 110 is split into the three display areas, the display areas each may independently display content and respond to a user operation, and the display areas may also be exchanged with each other.

In this embodiment of this application, when a touch control operation performed by the user on the screen 113 is collected, and a new display interface is displayed based on the touch control operation, the new display interface may be displayed on a secondary screen of a current display interface by default.

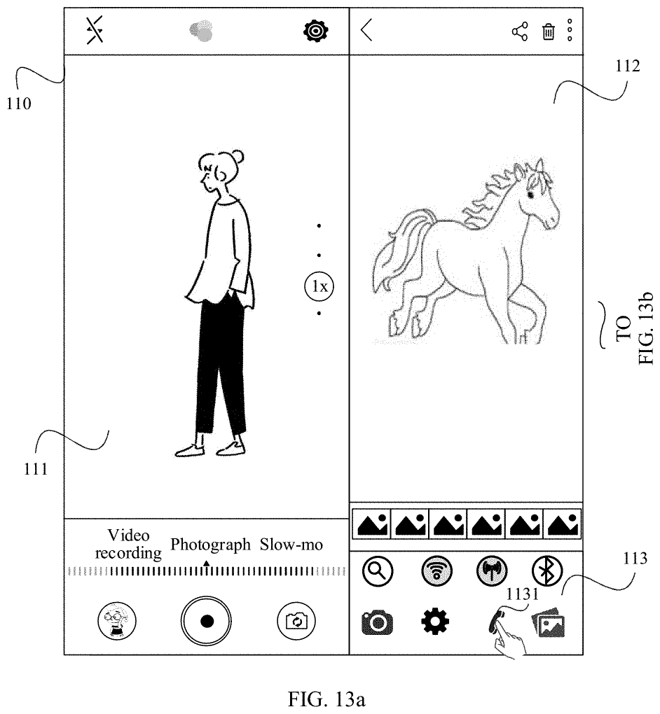

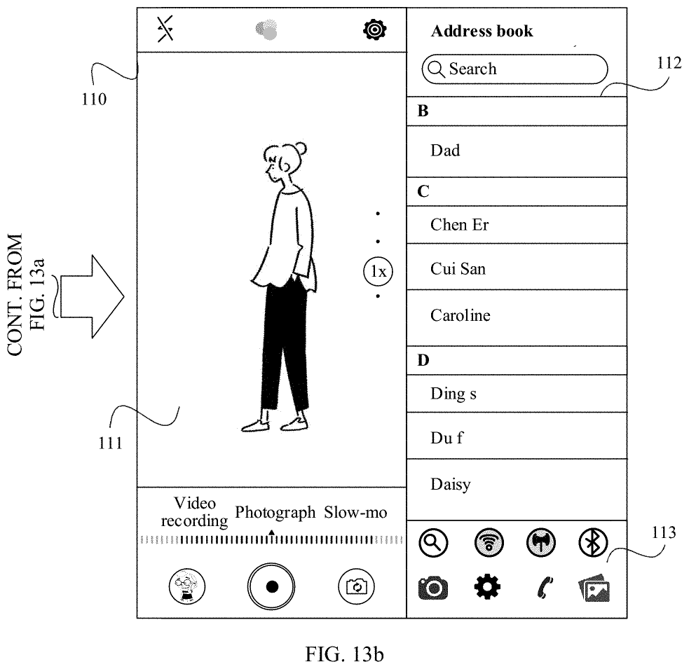

For example, FIG. 13a and FIG. 13b are a schematic diagram of other display interfaces of a mobile phone 100 in an unfolded state. As shown in an interface in FIG. 13a, a user may tap an icon control 1131 on a screen 113 to open a phone application. In this case, in response to the touch control operation, the mobile phone 100 may start the phone application, and display a display interface of the phone application on a screen 112 (a secondary screen).

A default display interface of each application is not particularly limited in this embodiment of this application. The phone application is used as an example. For example, a default display interface of the phone application may be an address book (or referred to as a phone book or a phone list) in an interface shown in FIG. 13b. For another example, a default display interface of the phone application may be a keyboard, so that the user enters a number. For another example, a default display interface of the phone application may alternatively be a recent call list. It is not described herein.

In addition, in another embodiment, when a touch control operation performed by the user on the screen 113 is collected, and a new display interface is displayed based on the touch control operation, the new display interface may be displayed on a primary screen of the current display interface by default, namely, on a screen 111 in FIG. 13a and FIG. 13b. Details are not described.

In another embodiment, if a new to-be-displayed display interface is currently started based on the touch control operation performed by the user, for example, if the user taps a code scanning control on the screen 113, and the mobile phone 100 needs to start a camera application in response to the touch control operation, to perform code scanning by using a camera, in this case, as shown in the interface shown in FIG. 13a, the camera application has been started on the primary screen 111, and does not need to be started repeatedly. In this case, a display interface is still the interface shown in FIG. 13a.

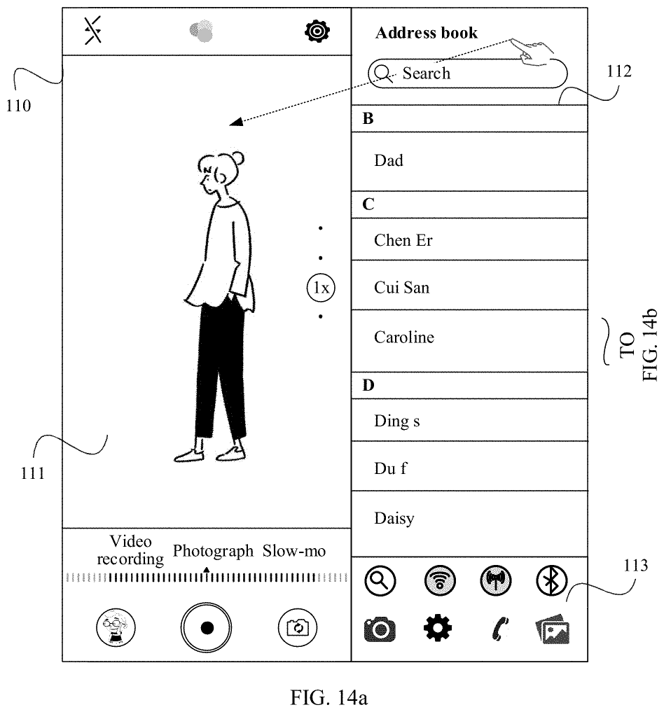

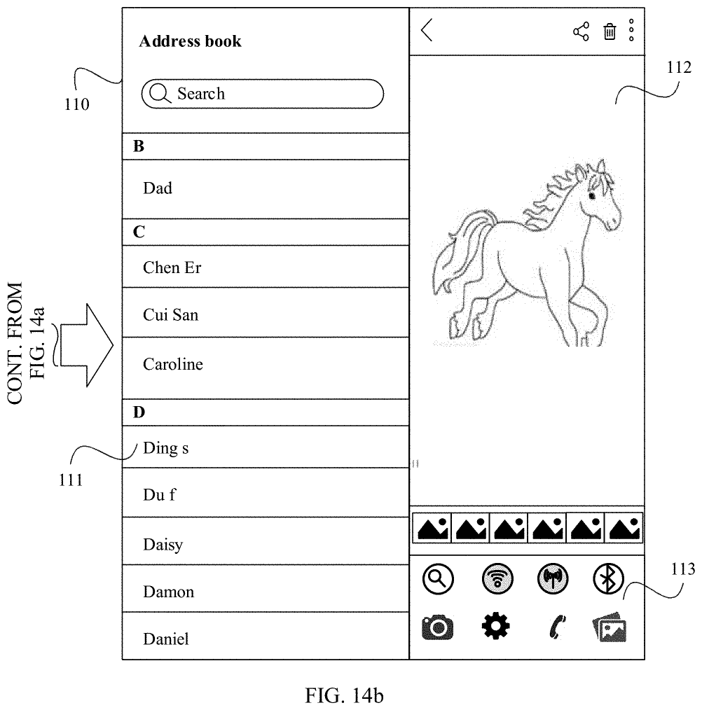

In this embodiment of this application, content in the display areas may be exchanged with each other. For example, FIG. 14a and FIG. 14b show a possible case. As shown in an interface in FIG. 14a, a user may drag an address book interface displayed on a screen 112 to an area on a screen 111. In this way, when the user lifts a finger, the mobile phone 100 can display the address book interface on the screen 111 in response to the touch control operation.

The screen 112 may display a display interface of an application previously displayed on the screen 112. In this case, as shown in an interface in FIG. 14b, the screen 112 displays a display interface of an album application. In this way, the drag operation adjusts display areas in which the applications are located. Alternatively, the screen 112 may display a display interface of a camera application. In this case, the screen 111 displays the address book interface. Compared with display areas in the interface in FIG. 14a, the display areas of the two applications are exchanged with each other. In this way, the user can switch, only through one drag operation, between the display interfaces on which the two applications are located.

In conclusion, in the unfolded state and the folded state of the mobile phone 100, when a length-width ratio of a display area or a screen of the mobile phone is greater than a preset size threshold, for example, 21:9, the screen can be split into a plurality of independent display areas. When the application content or the launcher content is normally displayed in one of the display areas, a plurality of shortcut controls are displayed in another display area. This facilitates a user operation and improves screen resource utilization.

In addition, if the length-width ratio of the display area or the screen of the mobile phone is less than another preset size threshold, for example, 4:3, the display area may also be split in the foregoing manner. This meets display requirements of an application and a launcher, and improves screen resource utilization.

In addition, in this embodiment of this application, when the mobile phone 100 is in the folded state (the state shown in FIG. 3c or the state shown in FIG. 3b), the sidebar 140 may implement some functions in addition to displaying content.

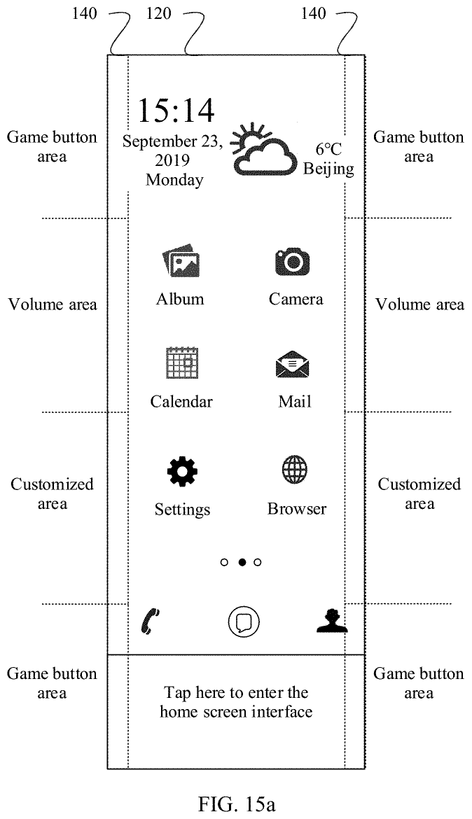

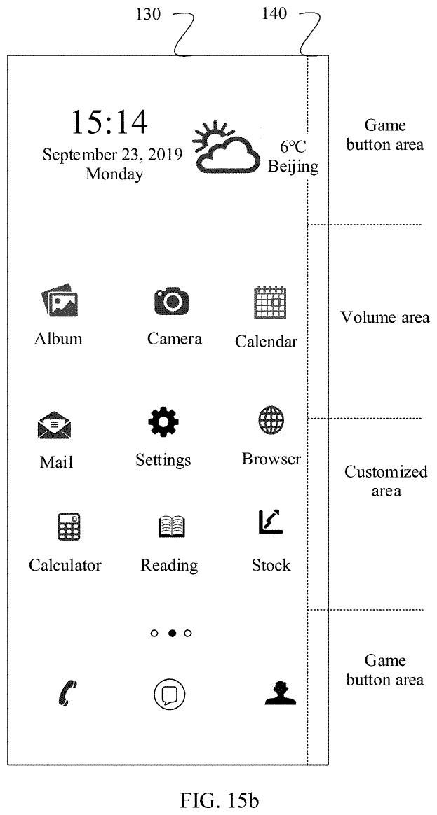

For example, FIG. 15a and FIG. 15b are a schematic diagram of other display interfaces of a mobile phone 100 in a folded state. When the mobile phone is in the folded state, there may be sidebars 140 formed by a screen on two sides of the screen 120 or a sidebar 140 formed by a screen on one side of the screen 120. Likewise, there may be sidebars 140 formed by a screen on two sides of the screen 130 or a sidebar 140 formed by a screen on one side of the screen 130. Sidebars on two sides of a screen may be different screens. For example, a sidebar in a rotating shaft area between the screen 120 and the screen 130 may be a flexible display, and the other sidebar away from the rotating shaft may be a common planar screen. Alternatively, the sidebars each may be a flexible display.

For example, FIG. 15a shows a case of the screen 120 and the sidebars 140 on the two sides, and FIG. 15b shows a case of the screen 130 and the sidebar 140 on the right side. In this case, the sidebar 140 and the screen 120 (or the screen 130) jointly display launcher content.

As shown in FIG. 15a and FIG. 15b, in this embodiment of this application, the sidebar 140 is split into four side areas, including two game button areas, one volume area, and a customized area. The volume area may be used to adjust volume in response to a touch control operation performed by a user. The game button area may assist a user in performing an operation when the mobile phone 100 runs a game application. Details are described subsequently. The customized area may be designed and customized by a user or a developer. Examples are provided subsequently.

Sizes and response manners of the four side areas obtained by splitting the sidebar 140 are not particularly limited in this embodiment of this application. For example, the sizes (lengths) of the four areas may be the same, or may be different. For example, the game button area may be large.

In this embodiment of this application, the sidebar 140 may respond to a plurality of touch control manners of the user, and the plurality of touch control manners may include but are not limited to one or more of sliding up (key move up), sliding down (key move down), touching and holding, tapping, and double-tapping. In this case, the side areas each respond to the touch control operations, and the touch control operations that can be responded to may be the same or different. For example, the volume area may respond to sliding up and sliding down performed by the user, and the game button area may respond to the foregoing five touch control operations.

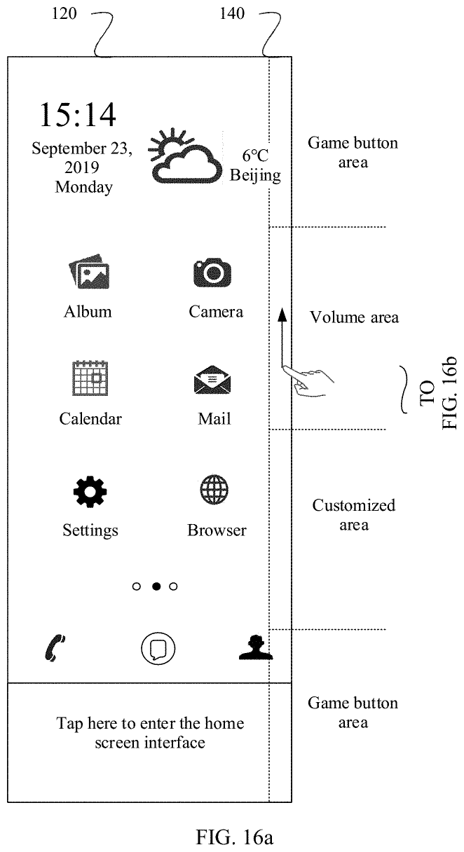

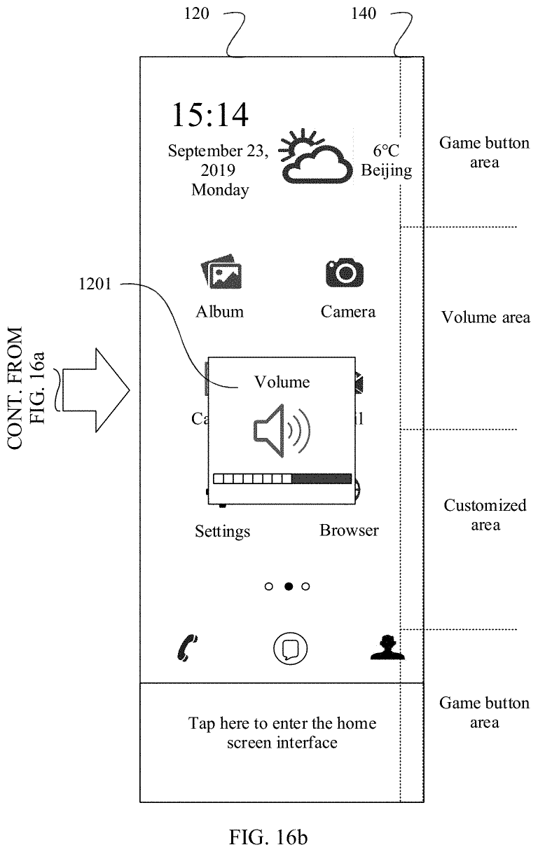

For example, FIG. 16a and FIG. 16b show a possible design of a volume area. As shown in an interface in FIG. 16a, when a mobile phone is in a folded state, and a screen 120 works to display content and respond to a user, a sidebar 140 on the right side of the screen 120 is also turned on, and displays content together with the screen 120. Then, if the user slides a finger upward in the volume area, the mobile phone 100 may increase current volume in response to the touch control operation. In addition, as shown in an interface in FIG. 16b, a prompt control 1201 may be displayed in a current display interface. The prompt control 1201 is used to prompt the user that the volume is currently being adjusted. A volume bar on the prompt control 1201 also extends rightwards as the volume increases, and extends leftwards as the volume decreases.

The touch control operation performed by the user in the volume area is applicable to adjustment of volume of a loudspeaker, and is also applicable to adjustment of volume of a headset. In addition, such volume adjustment manner is applicable to a launcher interface, or is applicable to a display interface of any app. In other words, after the screen is turned on, the volume area may be used to adjust the volume in response to the touch control operation performed by the user.

In the volume area, the volume may be adjusted through another touch control operation in addition to sliding up and down. For example, the mobile phone 100 may increase the current volume of the mobile phone in response to a double-tap operation performed by the user in the volume area, or may decrease the volume of the mobile phone in response to a tap operation performed by the user in the volume area. In an actual scenario, a touch control operation corresponding to increasing volume and a touch control operation corresponding to decreasing volume may be set by default in the mobile phone 100, or may be customized by the user.

In another embodiment of this application, the sidebar 140 may not display content together with the screen 120. For example, the screen 120 displays the interface of the launcher or the application in the manner shown in FIG. 4a to FIG. 9. The sidebar 140 may be fixedly displayed in black, and does not display launcher content or app content. In this case, the sidebar 140 may also adjust the volume in response to the touch control operation performed by the user in the foregoing manner.

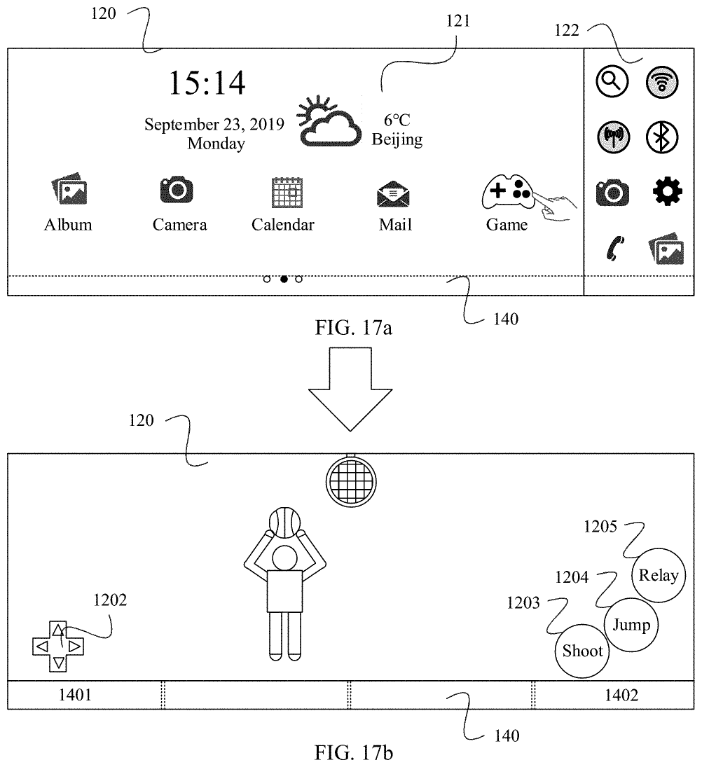

For example, FIG. 17a and FIG. 17b show a possible design of a game area. As shown in an interface in FIG. 17a, a user may tap a game icon control, to enter an interface shown in FIG. 17b. For example, the interface shown in FIG. 17b shows a schematic diagram of a basketball shooting game. A basketball shooting scenario and operation controls are displayed in the display interface of the basketball shooting game. The basketball shooting scenario may include but is not limited to a basketball basket, a basketball, and a virtual man. The operation controls may include an arrow button control 1202 used for controlling the virtual man to move, a control 1203 used for controlling the virtual man to perform basketball shooting, a control 1204 used for controlling the virtual man to jump, and a control 1205 used for controlling a relay of another virtual man (not shown in FIG. 17b). For example, in this scenario, the user may touch and control the arrow button control 1202 by using the left hand, to control the virtual man to move, and touch and control the control 1203 by using the right hand, to control the virtual man to perform basketball shooting.

As shown in FIG. 17b, the user may touch and control the controls by using the left hand or the right hand to complete the game, but various combined skills are hard to be implemented due to the limited operation manner. For example, the combined skills such as accelerated basketball shooting, fancy basketball shooting (for example, slam dunk), or alley-oop cannot be implemented by relying only on the controls displayed on a screen 120. In this case, two game button areas (1401 and 1402) in a sidebar 140 may be used to compensate for the disadvantage.

For example, in a possible embodiment, the user may touch and hold the game button area 1401 to implement an acceleration function. For example, the user may touch and hold the game button area 1401 by using the left hand, and touch and control the control 1203 by using the right hand, to implement the accelerated basketball shooting skill. For another example, the user may touch and hold the game button area 1401 by using the left hand, and touch and control the control 1205 by using the right hand, to implement the alley-oop skill.

For example, in another possible embodiment, the user may touch and control the game button area 1402 to implement different basketball shooting skills. For example, the user may tap the game button area 1402 to implement a slam dunk skill. For another example, the user may touch and hold the game button area 1402 to implement the alley-oop skill, and the like.

Therefore, when playing the game by using the mobile phone 100, the user may use the two game button areas to assist in implementing various skills or combined skills, which can effectively improve playability of the game and help improve game experience of the user.

It may be understood that the game scenario shown in FIG. 17b is merely an example. In an actual scenario, how the game button area responds to a user operation may be adapted and designed in applications. This is not limited herein.

It should be noted that the game button area may take effect only when the mobile phone 100 runs a game application. For example, in a scenario shown in FIG. 16a and FIG. 16b, the mobile phone 100 is a launcher interface. In this case, even if the user performs a touch control operation in the game button area, the mobile phone 100 does not respond to the touch control operation performed by the user or perform a corresponding function or operation.

The customized area in the sidebar 140 may be adapted for the applications. For example, in a possible scenario, if the user currently plays music by using the mobile phone 100, the customized area may be used to implement a function such as music switching. For example, a previous song is played in response to an operation of swiping upwards by the user in the customized area; a next song may be played in response to an operation of swiping downwards by the user in the customized area; playing is paused in response to a touch control operation of tapping by the user in the customized area, and playing is resumed when the user taps again; and the music playing app may be closed in response to a touch and hold operation of the user in the customized area. In another possible scenario, the user views news by using the mobile phone 100. In this case, in response to a tap operation of the user on the upper part of the customized area, a page is scrolled up, or content on the upper part of a current page is slid for presentation; and in response to a tap operation of the user on the lower part of the customized area, the page is scrolled down or content on the lower part of the current page is slid for presentation.

Functions and convenient operations of the mobile phone 100 can be enriched based on the foregoing design of the sidebar 140, which improves playability of the mobile phone 100. The user can touch and control the mobile phone more conveniently, and has good experience.

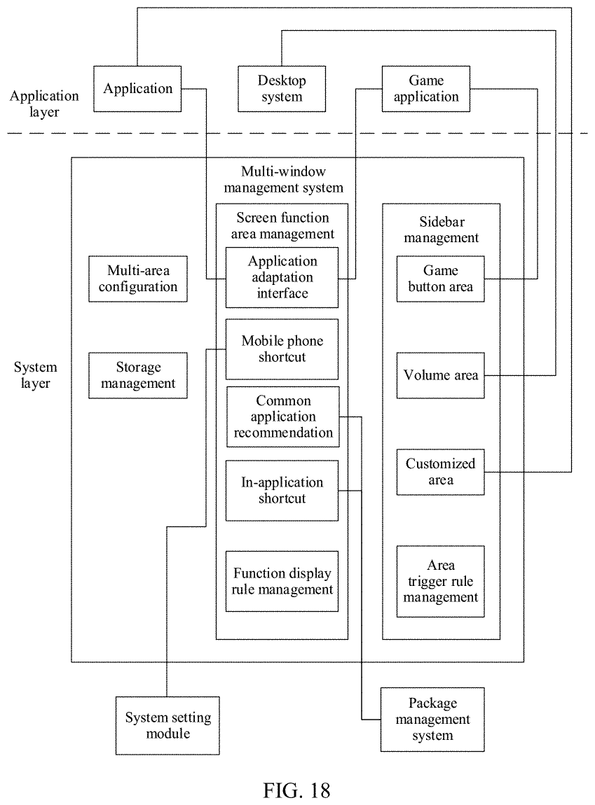

For example, refer to FIG. 18. FIG. 18 is a schematic diagram of a system architecture of a mobile phone 100. In this embodiment of this application, the mobile phone may include an application layer and a system layer.

The application layer may include a series of applications and a launcher system. For example, applications such as Camera, Gallery, Calendar, Phone, Map, Navigation, Bluetooth, Music, Video, and Messages may be installed at the application layer. For ease of describing a game button area on a sidebar, a game application is separately illustrated.

A multi-window management system is disposed at the system layer, and includes: a multi-area configuration module, a storage management module, a screen function area management module, and a sidebar management module.

The multi-area configuration module is configured to configure basic information of a function area (for example, a screen 122 of the mobile phone 100 in a folded state, or a screen 113 of the mobile phone 100 in an unfolded state) and a sidebar 140. Specifically, the multi-area configuration module may be configured to configure a screen split ratio, for example, how to split a screen 121 and a screen 122, or how to split a screen 110 into a screen 111, a screen 112, and a screen 113. The multi-area configuration module may be configured to configure content displayed in a function area, for example, controls to be displayed and how these controls respond to an operation. The multi-area configuration module may be configured to configure split positions of side areas on the sidebar, for example, the side areas are equally split, or the side areas are unequally split. The multi-area configuration module may be configured to configure functions to be enabled in the side areas.

The storage management module is configured to store a function manually configured by a user. For example, the storage management module may be configured to store a presentation manner that is used when a screen 110 enters a multi-application mode and that is selected by the user. For another example, the storage management module may be configured to store information about an application that is to be displayed on a screen 122 and that is selected by the user.

Screen function area management may include but is not limited to the following aspects: an application adaptation interface, a mobile phone shortcut, common application recommendation, an in-application shortcut, and function display rule management.

As shown in FIG. 18, the application adaptation interface is used to provide an interface, so that an application, including a game application, may present an icon in a function area and respond to a user operation.

The mobile phone shortcut may be connected to a system setting (Setting) module in the mobile phone 100, to provide various shortcuts for the user, for example, enabling Wi-Fi.

The common application recommendation is related to the application displayed in the application area. As described above, ranking may be performed based on use data of the user, such as a quantity of starting times and use duration, and icon controls of the top one or more ranked applications are displayed in the function area. In addition, the user may manually add an application displayed in the function area. In this case, a ranked priority of the application manually added by the user is higher than an automatically ranked priority based on frequency of being used the user, and an icon control of the application added by the user is preferably displayed in the function area.

The in-application shortcut (Shortcut) may be adaptable through a standard shortcut interface. In an actual use process, the in-application shortcuts may also be automatically ranked and displayed by the mobile phone based on data used by the user, or may be manually set by the user. A manually set shortcut has a higher priority.

Common application recommendation and a shortcut can be obtained from a package manage system (Package Manage System, PMS). The PMS is located at the system layer of the mobile phone 100, and is configured to manage a package (Package).

The function area display rule management is used to manage content displayed in the function area. Specifically, the function display rule management may be used to manage a display sequence and a display manner of the content in the function area. For example, content customized by the user is preferably displayed, a shortcut of a foreground application may be followed by a shortcut application of the mobile phone and an icon control of an application.

The sidebar management module includes the following aspects: a game button area, a volume area, a customized area, and area trigger rule management.

The volume area can be associated with the launcher (Launcher) system. The user can adjust volume on the launcher. In addition, the volume area may be associated with an application (including a game application) (not shown in FIG. 18). In this way, the user can also touch and control the volume area on the sidebar in the display interface of the application, to adjust the volume.

The game button area is associated with a game application. When the user starts the game application, the game button area may assist the user in performing an operation, to provide better operation experience for the user in the game application.

The customized area can be customized by an application.

The area trigger rule management is used to manage response rules of the side areas on the sidebar. For example, the area trigger rule management is used to manage the side areas, such as the game button area, when to respond, and how to respond to a user operation.

In the system architecture shown in FIG. 18, after the mobile phone 100 is started, the multi-window management system also starts to work, and the multi-area configuration module can be invoked to load configurations of screens (or display areas). For example, that a length-width ratio of a function area may be 9:4, the sidebar may be equally split into the side areas, and functions of the side areas may be loaded.

In one aspect, the multi-window management system may determine whether a function area (a screen 122 or a screen 113) needs to be displayed. Then, when a length-width ratio of a screen is greater than 21:9 or less than 4:3, or when the mobile phone is triggered to implement the multi-application mode in the manner shown in FIG. 11a and FIG. 11b, the multi-window management system may initialize the function area. Specifically, setting data of the user recorded in the storage management module may be obtained, an application frequently used by the user or an in-application shortcut may be determined based on data recorded in the PMS, and the mobile phone shortcut, or the like may be obtained. In this way, the function area is displayed based on the obtained data.

On the other side, the multi-window management system may determine whether the sidebar needs to respond to the user operation, so as to implement a specified function. For example, the volume area is enabled, so that the user can conveniently perform the touch control operation to adjust the volume. For another example, the game button area is enabled, so that the user controls and touches the game button area to implement a game skill. In this case, if it is determined that the sidebar responds to the user operation, the sidebar may be configured, and a touch event on the sidebar is listened to. Therefore, the side areas perform response based on the detected touch event.

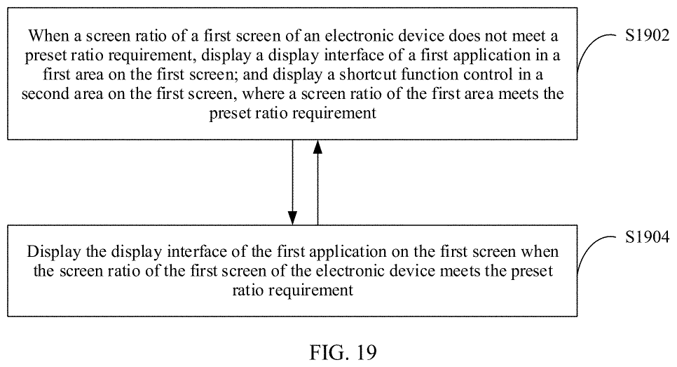

With reference to FIG. 19, a display method for an electronic device according to an embodiment of this application is described. As shown in FIG. 19, the method includes the following steps:

S1902: When a screen ratio of a first screen of the electronic device does not meet a preset ratio requirement, display a display interface of a first application in a first area on the first screen; and display a shortcut function control in a second area on the first screen, where a screen ratio of the first area meets the preset ratio requirement.

S1904: Display the display interface of the first application on the first screen when the screen ratio of the first screen of the electronic device meets the preset ratio requirement.

For a part that is not described in detail in the method, refer to the foregoing embodiments. Details are not described herein again.

An embodiment of this application provides a computer storage medium, including computer instructions. When the computer instructions are run on an electronic device, the electronic device is enabled to perform the method according to any possible design of any one of the foregoing aspects.

An embodiment of this application provides a computer program product. When the computer program product runs on a computer, the computer is enabled to perform the method according to any possible design of any one of the foregoing aspects.

The foregoing implementations of embodiments of this application may be randomly combined to implement different technical effects.

All or some of the foregoing embodiments may be implemented by using software, hardware, firmware, or any combination thereof. When software is used to implement embodiments, all or some of embodiments may be implemented in a form of a computer program product. The computer program product includes one or more computer instructions. When the computer program instructions are loaded and executed on a computer, the procedures or functions according to embodiments of this application are all or partially generated. The computer may be a general-purpose computer, a dedicated computer, a computer network, or another programmable apparatus. The computer instructions may be stored in the computer-readable storage medium or may be transmitted from a computer-readable storage medium to another computer-readable storage medium. For example, the computer instructions may be transmitted from a website, computer, server, or data center to another web site, computer, server, or data center in a wired (for example, a coaxial cable, an optical fiber, or a digital subscriber line) or wireless (for example, infrared, radio, or microwave) manner. The computer-readable storage medium may be any usable medium accessible by a computer, or a data storage device, such as a server or a data center, integrating one or more usable media. The usable medium may be a magnetic medium (for example, a floppy disk, a hard disk, or a magnetic tape), an optical medium (for example, a DVD), a semiconductor medium (for example, a solid-state drive Solid-State Drive), or the like.

In conclusion, the foregoing descriptions are merely embodiments of the technical solutions of the present invention, but are not intended to limit the protection scope of the present invention. Any modification, equivalent replacement, or improvement made according to the disclosure of the present invention shall fall within the protection scope of the present invention.

Apparently, a person skilled in the art can make various modifications and variations to the present invention without departing from the spirit and scope of the present invention. The present invention is intended to cover these modifications and variations provided that they fall within the scope of protection defined by the following claims and their equivalent technologies.

1.-36. (canceled)

37. A method implemented by a mobile terminal, wherein the method comprises:
displaying a first interface comprising a first area displaying a first application, a second area displaying at least three shortcut function controls, and a third area displaying a second application, wherein the at least three shortcut function controls comprise a first icon control related to the first application, a second icon control related to the second application, and a third icon control related to a third application;
receiving a first operation on the third icon control;
displaying, in response to the first operation, a second interface comprising the first area, the second area, and the third area, wherein, in the second interface, the first application is still displayed in the first area, the third application is displayed in the third area, and the first icon control, the second icon control, and the third icon control are still displayed in the second area;
receiving a second operation on the third application;
displaying, in response to the second operation, a third interface,
wherein the third interface comprises the first area, the second area and the third area,
wherein, in the third interface, the first application is displayed in the third area, the third application is displayed in the first area, and the first icon control, the second icon control, and the third icon control are still displayed in the second area.

38. The method of claim 37, wherein the first icon control is the same as a first icon of the first application represented on a home screen of the mobile terminal, wherein the second icon control is the same as a second icon of the second application represented on the home screen, and wherein the third icon control is the same as a third icon of the third application represented on the home screen.

39. The method of claim 37, wherein the mobile terminal is a foldable phone and is in an unfolded state when receiving the second operation.

40. The method of claim 37, wherein the second operation is a drag operation starting from the third area to the first area.

41. The method of claim 37, wherein the second operation is a drag operation starting from a top area of the third area.

42. The method of claim 37, wherein the second area is displayed on a bottom of the mobile terminal.

43. The method of claim 37, wherein the first icon control, the second icon control, and the third icon control are displayed on a bottom-right of the mobile terminal.

44. The method of claim 37, wherein the first area is displayed adjacent to the third area and on a right side of the third area.

45. The method of claim 37, wherein the first area and the third area are different in size.

46. An electronic device, comprising:
a processor; and
a memory coupled to the processor and configured to store instructions, wherein when executed by the processor, the instructions cause the electronic device:
display a first interface comprising a first area displaying a first application, a second area displaying at least three shortcut function controls, and a third area displaying a second application, wherein the at least three shortcut function controls comprise a first icon control related to the first application, a second icon control related to the second application,_ and a third icon control related to a third application;
receive a first operation on the third icon control;
display, in response to the first operation, a second interface comprising the first area, the second area, and the third area, wherein, in the second interface, the first application is still displayed in the first area, the third application is displayed in the third area, and the first icon control, the second icon control, and the third icon control are still displayed in the second area;
receive a second operation on the third application;
display, in response to the second operation, a third interface comprising the first area, the second area, and the third area,
wherein, in the third interface, the first application is displayed in the third area, the third application is displayed in the first area, and the first icon control, the second icon control, and the third icon control are still displayed in the second area.

47. The electronic device of claim 46, wherein the first icon control is the same as a first icon of the first application on a home screen of the electronic device, wherein the second icon control is the same as a second icon of the second application on the home screen, and wherein the third icon control is the same as a third icon of the third application on the home screen.

48. The electronic device of claim 46, wherein the electronic device is a foldable phone and is in an unfolded state when receiving the second operation.

49. The electronic device of claim 46, wherein the second operation is a drag operation starting from the third area to the first area.

50. The electronic device of claim 46, wherein the second operation is a drag operation starting from a top area of the third area.

51. The electronic device of claim 46, wherein the second area is displayed on a bottom of the electronic device.

52. The electronic device of claim 46, wherein the first icon control, the second icon control, and the third icon control are displayed on a bottom-right of the electronic device.

53. The electronic device of claim 46, wherein the first area is displayed adjacent to the third area and on a right of the third area.

54. The electronic device of claim 46, wherein the first area and the third area are different in size.

55. A computer program product comprising computer-executable instructions that are stored on a non-transitory computer-readable storage medium and that, when executed by a processor, cause an electronic device to:
display a first interface comprising a first area displaying a first application, a second area displaying at least three shortcut function controls, and a third area displaying a second application, wherein the at least three shortcut function controls comprise a first icon control related to the first application, a second icon control related to the second application, and a third icon control related to a third application;
receive a first operation on the third icon control;
display, in response to the first operation, a second interface comprising the first area, the second area, and the third area, wherein, in the second interface, the first application is still displayed in the first area, the third application is displayed in the third area, and the first icon control, the second icon control, and the third icon control are still displayed in the second area;
receive a second operation on the third application;
display, in response to the second operation, a third interface comprising the first area, the second area, and the third area,
wherein, in the third interface, the first application is displayed in the third area, the third application is displayed in the first area, and the first icon control, the second icon control, and the third icon control are still displayed in the second area.

56. The computer program product of claim 55, wherein the first icon control is the same as a first icon of the first application on a home screen of the electronic device, wherein the second icon control is the same as a second icon of the second application on the home screen, and wherein the third icon control is the same as a third icon of the third application on the home screen.
